(19) United States
(12) Patent Application Publication
(10) Pub. No.: US 2013/0166391 A1
(43) Pub. Date: Jun. 27, 2013

(54) CROWD-DETERMINED FILE UPLOADING METHODS, DEVICES, AND SYSTEMS

(71) Applicants: Anthony T. BLOW, San Diego, CA (US); Manas ABICHANDANI, San Diego, CA (US); Jose R. MENENDEZ, San Diego, CA (US); Babak FORUTANPOUR, Carlsbad, CA (US); David L. BEDNAR, San Diego, CA (US)

(72) Inventors: Anthony T. BLOW, San Diego, CA (US); Manas ABICHANDANI, San Diego, CA (US); Jose R. MENENDEZ, San Diego, CA (US); Babak FORUTANPOUR, Carlsbad, CA (US); David L. BEDNAR, San Diego, CA (US)

(21) Appl. No.: 13/338,200

(22) Filed: Dec. 27, 2011

(51) Int. Cl. G06Q 30/02; G06F 15/16; G06F 3/01

(52) U.S. Cl. 705/14.66; 715/738

(57) ABSTRACT

Various embodiments include methods for uploading files to a social media website, including receiving in a computing device a user input identifying files for upload to a social media website, selecting one or more files representative of the selected files, uploading the representative files to a social media website server, receiving in the computing device from the social media website server a request for upload of files similar to identified particular representative files, and uploading the additional files that are similar to the identified particular representative files. The social media website server may determine the popularity of files based on user interactions with the files, and request additional files similar to the particular uploaded files when the interactions exceed a popularity threshold.

### BACKGROUND

Many users of smart phones and tablet computers have cellular network data plans which limit the amount of data that can be uploaded or downloaded within a given time period. For this given time period users typically pay a fixed fee (e.g., monthly fee). When users upload or download data beyond their limit, the fees for each additional megabyte transmitted can be quite expensive. This is particularly true in many countries outside the United States. For this reason, users are often careful about the information they upload to social network websites, such as photographs and videos. Nevertheless, many users are interested in sharing photographs, audio files and video files that they believe their social media friends would be interested in. This creates a natural tension between the desire to share media with social media “friends” and the desire to save money by economizing the use of mobile data communications services.

### SUMMARY

The various embodiments include methods for uploading files to a social media website, including receiving a user input identifying files for upload to a social media website, selecting one or more files representative of the selected files, uploading the selected one or more representative files from the user's computing device to the social media website server, receiving in the user's computing device from the social media website server a request for upload of files similar to identified particular representative files, and uploading from the user's computing device to the social media website server additional files that are similar to the identified particular files.

Further embodiment methods may include posting in a server of the social media website the received selected one or more representative files to the social media website, tracking in the server interactions of users of the social media website with the posted one or more representative files, determining in the server when the user interactions with a particular uploaded file exceeds a popularity threshold value, transmitting a request from the server to the originating user's computing device for upload of additional files that are similar to the particular uploaded file having interactions exceeding the popularity threshold value, and posting in the server the additional files on the social media website.

Various embodiments include mobile computing devices and servers including processors configured to perform operations of the embodiment methods disclosed herein. Various embodiments also include mobile computing devices and servers including means for performing functions of the embodiment methods disclosed herein. Various embodiments also include non-transitory processor- and server-readable storage media having stored thereon processor-executable instructions configured to cause a processor to perform operations of the embodiment methods disclosed herein.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the various embodiments.

FIG. 1 is a system diagram of a communication network suitable for use with various embodiments.

FIG. 2 is a process flow diagram of an embodiment method for uploading files to a social media website.

FIGS. 3A-3C are process flow diagrams of embodiment methods for uploading files to a social media website from a mobile computing device.

FIGS. 4A and 4B are process flow diagrams of embodiment methods for posting files to a social media website from a server.

FIGS. 5A-5C are process flow diagrams of embodiment methods for uploading higher-resolution versions of files to a social media website from a mobile computing device.

FIG. 6 is a process flow diagram of an embodiment method in which a mobile computing device sends a request for a higher-resolution version of a media file to the mobile computing device from which the file originated.

FIG. 7 is a process flow diagram of an embodiment method in which an executable program embedded in a downloadable media file sends a request for a higher-resolution version of the file based on the popularity of the file.

FIG. 8 is a process flow diagram of an embodiment method in which an executable program embedded in a downloadable media file enables a user to request a higher-resolution version of the file.

FIGS. 9A and 9B are process flow diagrams of embodiment methods for initially uploading representative media files to a social media website, and later uploading additional files based on the popularity of the representative files.

FIGS. 9C and 9D are process flow diagrams of embodiment methods for requesting additional files similar to representative files posted on a user's social media website.

FIG. 10 is a process flow diagram of an embodiment method for uploading media files to a social media website in which a user may opt to have advertising displayed with the media files.

FIG. 11 is a process flow diagram of an embodiment method for uploading media files to a social media website using a content editor.

FIG. 12 is a component block diagram of an embodiment mobile computing device suitable for use in various embodiments.

FIG. 13 is a perspective view of an embodiment computing device suitable for use as a server in various embodiments.

FIG. 14 is a component block diagram of an embodiment laptop computer device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “computing device” and “mobile computing device” refer to a variety of computer devices, including but not limited to smartphones, cellular telephones, personal television devices, personal data assistants (PDAs), palm-top computers, digital cameras configured with wireless communication capabilities, including memory sticks with wireless modems, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, receivers within vehicles (e.g., automobiles), interactive game devices, notebooks, smartbooks, netbooks, tablets (e.g., Apple®, iPad®, Samsung®, Galaxy®), mobile television devices, wireless modem dongles, computers (e.g., laptop computers) coupled to a wireless modem, computers coupled to a dongle, or other portable programmable computing devices.

As used herein, the terms “social media website” and “social networking website” refer to a variety of an online services, platforms and websites that enable users to upload and exchange media content over a network, such as the internet and/or a mobile network, within a community of users of the online service, platform or website. The media content may include pictures, video, audio and games. Examples of social media websites include, for example, Facebook®, Twitter®, MySpace®, Youtube®, Flickr®, Photobucket®, Dailymotion®, etc.

In overview, the various embodiments enable reduced use of mobile data communication services by uploading to social media websites reformatted media files which have reduced resolution (e.g., downsized) or represent a sample of types of files, and enabling the user's “friends” and social media contacts to identify the uploaded media files which are of most interest so that only the popular images or files are uploaded in full or enhanced fidelity. In a manner of speaking, various embodiments enable the “crowd” to select the most popular images for full or enhanced fidelity upload, so that a user's mobile data megabytes are used primarily to transmit popular images, and not wasted on images of little interest to friends and associates.

Various embodiments may be implemented on mobile computing devices, and particular smart phones and digital cameras configured with wireless communication capabilities. Embodiments may also be partially implemented on servers associated with social media websites, for example, Facebook®. Implemented within a mobile computing device, embodiments of the invention may be in the form of an application or functionality associated with a communication and/or photography application. Implemented within a server, embodiments of the invention may involve additional functionality associated with the uploading and posting of a user's audio, video and image content in a user's social media page or website.

Some embodiments may be implemented within a mobile computing device which is configured with functionality to compresses files or reduces the quality of images, video and/or audio files so that they can be transmitted using the user's mobile communication data plan in a reduced resolution (i.e., compact) format. In the example of digital image files, the photographs may be downsized and compressed into thumbnail images which can be transmitted in very few kilobytes of information. These downsized images (or other files) may then be uploaded to the user's social media website using conventional wireless communication methods (e.g., 3G or 4G data communication services). Since the images (or other files) have been downsized or compressed, the amount of data that is transmitted is relatively small compared to the full fidelity files. Consequently, the amount of data units of a user's data plan required to accomplish the uploaded/downloaded is dramatically reduced. This conserves data plan usage units available in the user's data plan for other uses, while enabling the user to upload a large number of images (or other files) to his or her social media website. These files are then posted on the user's social media website in the ordinary manner.

Since the images (or other files) have been downsized or compressed, the quality or information available within those images and files is a small fraction of the original full fidelity file. Thus, when a friend or associate of the user clicks on a file on the user's social media website, the low-quality image (or other file) will be accessed. This provides the viewer with a thumbnail or low-quality version of the image or file, which may be enough to enable the viewer to decide whether the photograph or file is of interest and worth viewing in full (or nearly full) resolution. If the viewer is interested in the file, the viewer may make a selection or otherwise provide an input which allows the social media website to provide the file. The website hosting server may be configured to determine the relative popularity of the user's posted files or request for the full resolution image file. The viewer may have an interaction with the photograph or file of interest, such as by interacting with the social media server to comment on the file, rate the file (e.g., indicating the viewer “likes” the file), tag the file, link to the file, or forward the file to other user(s).

The social media server may count the number of requests for, accesses of or other interactions with particular files to determine whether there is sufficient interest in the full resolution image or file to justify the bandwidth consumption to upload a higher resolution version. If so, the social media server may send a message to the originating (i.e., downloading) computing device requesting an upload of a higher resolution version of the particular file. This determination by the social media server may involve comparing the number of accesses, requests or interactions to a threshold value which may be set by users in setting up their social media website. In other embodiments, the social media server may assess the number and quality of interactions users have with a particular media file, and if the interactions meet a predetermined threshold of “popularity,” the social media server may request an upload of a higher resolution version of the file. In response to receiving such a request, the user's computing device may upload a higher resolution version or even the full resolution version of the requested image or other file. The uploading of this image or file may be accomplished using the normal wireless data communication process. Finally, the social media server is configured to substitute the higher resolution file or image for the original low resolution image/file in the user's page. Thus, the uploaded second higher resolution version is not a new image or file, but may be a higher resolution replacement for the original. In various embodiments, the social media server may retain the lower-resolution version of the file, and may make the lower-resolution version available to download to a user's computing device. For example, embodiments may include enabling the computing devices of users to opt to download lower-resolution versions of files when higher-resolution versions of the files are available. This embodiment may enable users to save wireless charges by electing to download the smaller size version of the file.

The various embodiments enable users to upload digital media in a manner that reduces the amount of megabytes used in the initial upload so that a full selection of images may be provided, while users' data plans can be utilized more efficiently to upload higher-resolution versions of images or other files that are of real interest to friends and associates. The embodiments enable users to share with their friends a large number of photographs (or other files) economically, with only those photographs (or other files) that are popular receiving a full resolution transmission treatment.

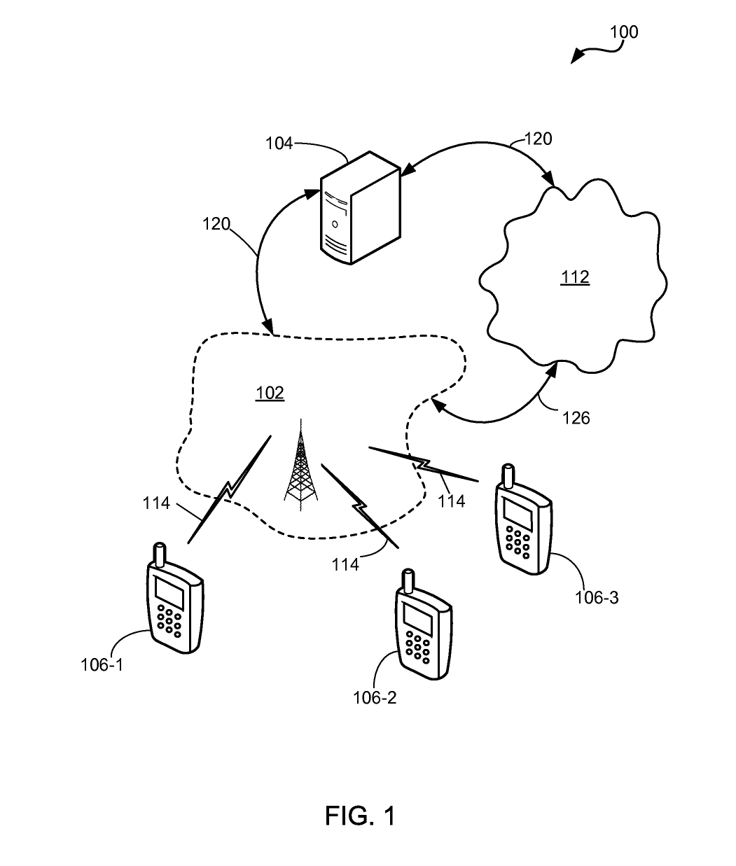

FIG. 1 illustrates an exemplary communication system 100 that may be used to enable a plurality of users to upload, view and or exchange media content on a social media website. The communication system 100 may make use of a wireless communication network 102, such as a cellular telephone network, Wi-Fi network, or combinations of both cellular and Wi-Fi networks. The wireless communication network 102 may be coupled to the Internet 112, such as via an Internet gateway connection 126. One or more social media website servers 104 may be coupled to the wireless communication network 102 by a local area network 120 or the Internet 112. While FIG. 1 shows the network connections 120 as physical connections, wireless network connections may also be used. The wireless communication system 102 may provide wireless communication services (e.g., cellular data networks or Wi-Fi) to a plurality of mobile computing devices 106-1, 106-2, 106-3 through wireless data links 114.

User mobile computing devices 106-1, 106-2, and 106-3 (collectively “mobile computing device 106”) include a processor and memory, and may send and receive data through a wireless data link 114. The mobile computing devices 106 may be configured with application software associated with one or more social media websites, the application software being stored in memory and executable by the processor. The mobile computing devices 106 may further have stored in memory one or more media content files, such as picture files, video files, audio files, etc. The mobile computing devices 106 may include hardware and/or software that enable the mobile computing devices 106 to create and store media content files. For example, the mobile computing devices 106 may include a digital camera for taking and storing picture and/or video files. The mobile computing devices 106 may use application software to upload media files to the social media website, where the media files may be viewable to other users of the social media website.

In many cases, the mobile computing device 106 may be limited in terms of how much data it can send or receive over wireless network 102. For example, the operator of the wireless network 102 may impose bandwidth limitations on users of the network. The user of a mobile computing device 106 may have a wireless network data plan which limits the amount of data that can be uploaded or downloaded on the network 102 within a given time period for a given fee (e.g., monthly fee). When a user exceeds these limits the network operator may impose overage fees that can be quite expensive. In some cases, the user of the mobile computing device 106 may have a prepaid plan, and the use of the plan to upload files to a social media website may unduly deplete reserves meant for other uses, such as phone calls, creating a frustrating experience. In one embodiment, the mobile computing device 106 may include software that tracks the amount of data used within a given time period (e.g., monthly) to help the user keep track of the data used and avoid excessive data use fees.

The social media website server 104 may receive the media files uploaded from user's device 106-1, and store the files, for example in a database or directory. The server 104 may receive requests sent over network(s) 102, 112 from other user's devices (e.g., mobile computing devices 106-2, 106-3) to view one or more media files uploaded by a user's mobile computing device 106-1. If the other user is authorized (e.g., the other user is a “friend” of the uploading user), the server 104 may download the requested media files to the other user' devices 106-2, 106-3 via the network 102, 112. The operator of the social media website may have a tension between the desire to enable its users to share high-resolution media content with one another, and the costs associated with storing and transmitting large amounts of high-resolution media content.

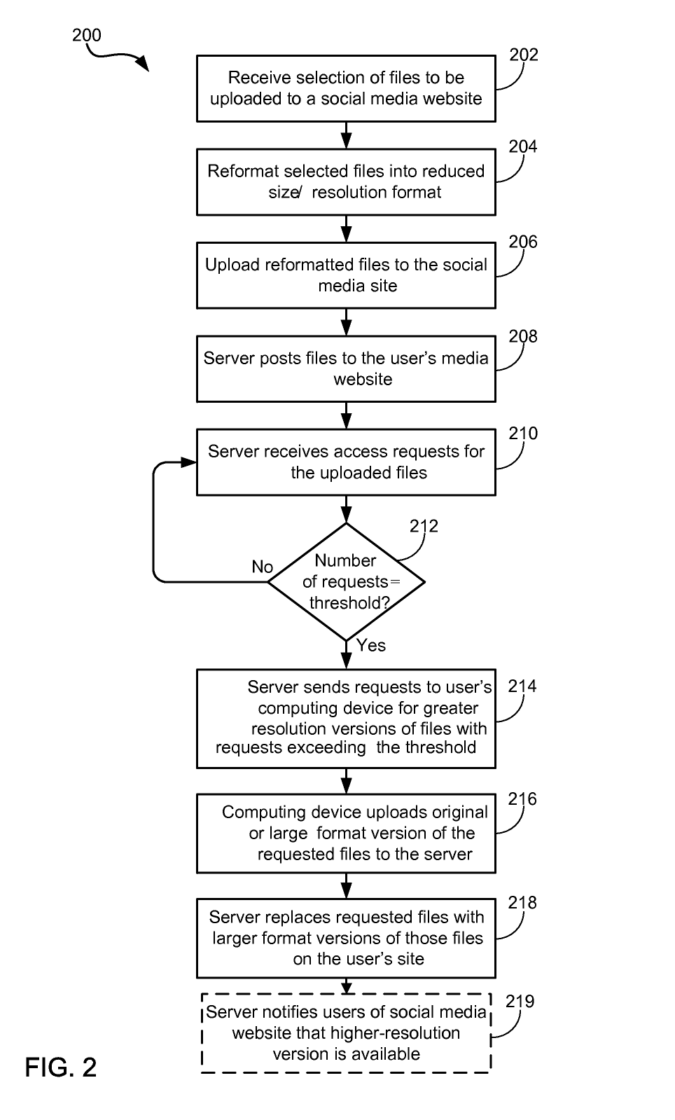

FIG. 2 illustrates an embodiment method 200 for uploading files to a social media website. In block 202 of method 200, a computing device, which may be a mobile computing device 106, may receive the user's selection of files to be uploaded to a social media website. The files may be media files, such as pictures, video and/or audio files. The media files may be stored on the device 106 in a full-size and/or full-resolution format (e.g., TIFF, JPEG, BMP, MPEG, etc.). The media files may also include text files, such as an article, publication or blog entry.

In block 204, the computing device may reformat the selected files into a reduced size and/or reduced resolution format, and in block 206, the computing device may upload the reformatted files to the social media website. The files may be reformatted using any known technique, such as by resizing or compression algorithms as are known in the art. The reformatting may be done by application software which runs on the mobile computing device 106. In some embodiments, the social media website may include a downloadable executable file (e.g., HTML code, JavaScript®, etc.) which runs on mobile computing device 106 and automatically reformats each media file before it is transmitted over wireless network 102 to social media server 104. The reformatted files require less bandwidth (e.g., megabytes) to transmit over the wireless network 102 than would the full-size/full-resolution versions of the same files. This enables users to upload more files without exceeding their data plan limits. The reformatted files may be, for example, cropped relative to the original files and/or support a lower resolution display (e.g., VGA 640×480 display, rather than a higher resolution display, such as WVGA or FWVGA). The reformatted media files may be a different type of file than the original files. For example, where the original file is a video file, the reformatted file may be one or more still images and/or audio portion(s) from the original file. Similarly, where the original file is a three-dimensional (3D) or holographic media file, the reformatted file may be a two-dimensional file. Where the original file is a text file, such as an article, publication or blog entry, the reformatted file may be, for example, a “headline” or title of the file, a portion of the file (e.g., the first paragraph), and/or a brief summary of the content of the file, which may be automatically generated using artificial intelligence software running on the user's computing device 106-1. The reformatted, lower-resolution files may include unique file metadata to facilitate the social media server 104 to later request upload of a higher-resolution version of the file based on user requests for or interactions with the file on a social media website.

In block 208, the social media server 104 posts the files to the user's media website. The social media server 104 may publish the files as thumbnail images, for example. In block 210, the server 104 receives requests from other users of the social media website to access the uploaded files. For example, user of a computing device 106-2, who is within the originating user's community on the social network (e.g., a “friend”), may visit a webpage of the originating user, and click on one or more selected media files (e.g., photos, videos, etc.). In response, the server 104 may transmit the reformatted, reduced-resolution versions of the selected files to the requesting computing device 106-2.

As part of block 210 the social media server 104 may keep a count of the number of access requests received for each media file uploaded to the server 104. In this way, the server 104 may track the “popularity” of each file. In block 212, the server 104 may compare the number of requests for a particular file to a threshold value. The threshold value may be determined by the social media server or set by the user. As an example, the threshold may be set to five requests. In an embodiment, the threshold value may be set by the user when the user uploads the files. While the number of received file access requests remains less than the threshold value (i.e., determination block 212=“No”), the server 104 may continue to receive requests for the file, and transmit the lower-resolution version.

When the number of requests equals or exceeds the threshold value (i.e., determination block 212=“Yes”), then in block 214 the server 104 sends a request to the user's mobile computing device 106-1 for a greater resolution version of the file. In various embodiments, the social media server 104 may contact the originating user's computing device 106-1 via one or more of SMS message, e-mail, HTML, or by a request communicated the next time the user's device 106-1 logs into the social media server.

In various embodiments, the mobile computing device 106 may have an application program for the social media website that runs in the background of the mobile computing device. The application program may be the program used to upload media files to the social media website, for example. This application may enable background communication over a network 102 between the mobile computing device 106-1 and the social media server 104, such as socket communication, TCP/IP communication, cellular data communications, etc. In various embodiments, the server 104 may use the background communication link with the mobile computing device 106-1 to request that the device upload a higher resolution version of a media file. Alternatively, the social media server 104 may contact the mobile computing device 106-1 over the network 102 as if the device 106-1 were a web server. For example, the social media server 104 may contact the mobile computing device 106-1 via a common protocol-running web server on the device 106-1. An authentication process may allow the social media server 104 to contact a URL to request a particular file on device 106-1. In other embodiments, the social media website may be integrated with an operating system running on mobile computing device 106-1. For example, the operating system may include a function enabling automatic uploading of media files generated by mobile computing device 106-1 (e.g., from a camera) to the social media website. In an embodiment, the social media server 104 may request a higher-resolution file from a computing device 106 by waking up that function on the device.

In another embodiment, the social media server 104 may contact the user's mobile computing device 106-1 via a voice call. The voice call may be automated, and employ voice recognition software so that a user may accept an invitation to upload a higher resolution image via voice commands or button presses.

In block 216, the mobile computing device 106-1 may respond to the request from the social media server by uploading a higher-resolution version of the file. The higher-resolution version of the file may be the original, full-format version of the file, or it may be a version of the file that is higher-resolution than the version first uploaded, but still reduced in size and/or resolution as compared to the full-format file. For example, where the original file is a 2 megapixel photograph, the originally uploaded version may be a low-resolution VGA (640×480) image, and the higher-resolution version uploaded in response to the request from the social media server 104 may be a 1 megapixel version of the photograph.

In block 218, the social media server 104 may receive the larger format, higher-resolution version of the requested file, and replace the original file with the received larger format version. In some embodiments, the social media server 104 is not posting a new file, but may replace one version of the file with a larger format, higher-resolution version of the same content (picture, video, etc.). The social media server 104 may replace the old file with the newly-uploaded file in its directory, or may add a pointer to the new file, for example. In various embodiments, any data associated with the content (e.g., a number of views, tags, comments, “likes” received from viewers of the file, etc.) may be retained by server 104 and associated with the larger format version of the file.

In some embodiments, the social media server may retain the lower-resolution version of the file, and may make the lower-resolution version available to download to a user's computing device. For example, embodiments may include enabling the computing devices of users to opt to download lower-resolution versions of files when higher-resolution versions of the files are available.

In embodiments, the social media server 104 may optionally notify computing devices of users of the social media website that a higher-resolution version of a particular file is available in optional block 219. For example, the server 104 may send a message or notification to computing devices which have previously accessed or downloaded the lower-resolution version of the file.

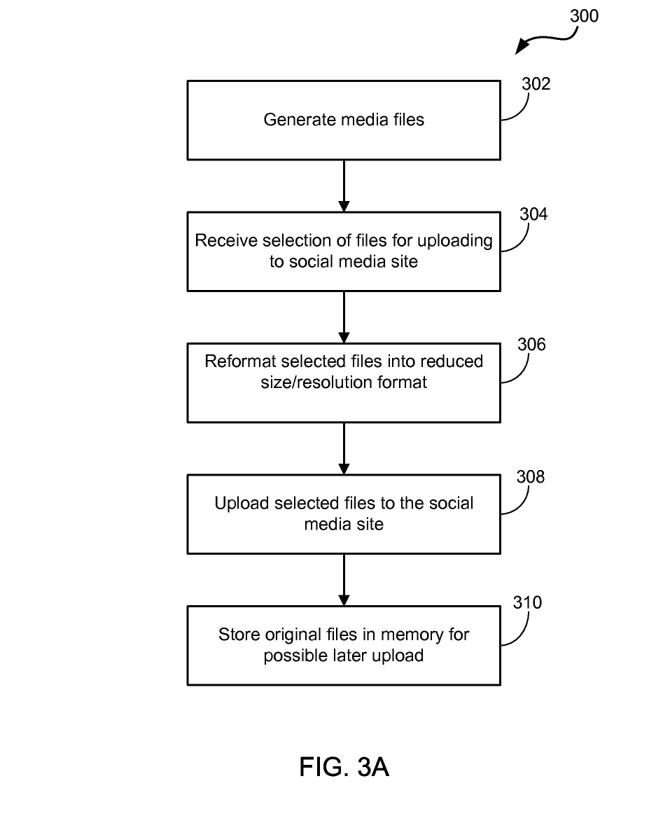

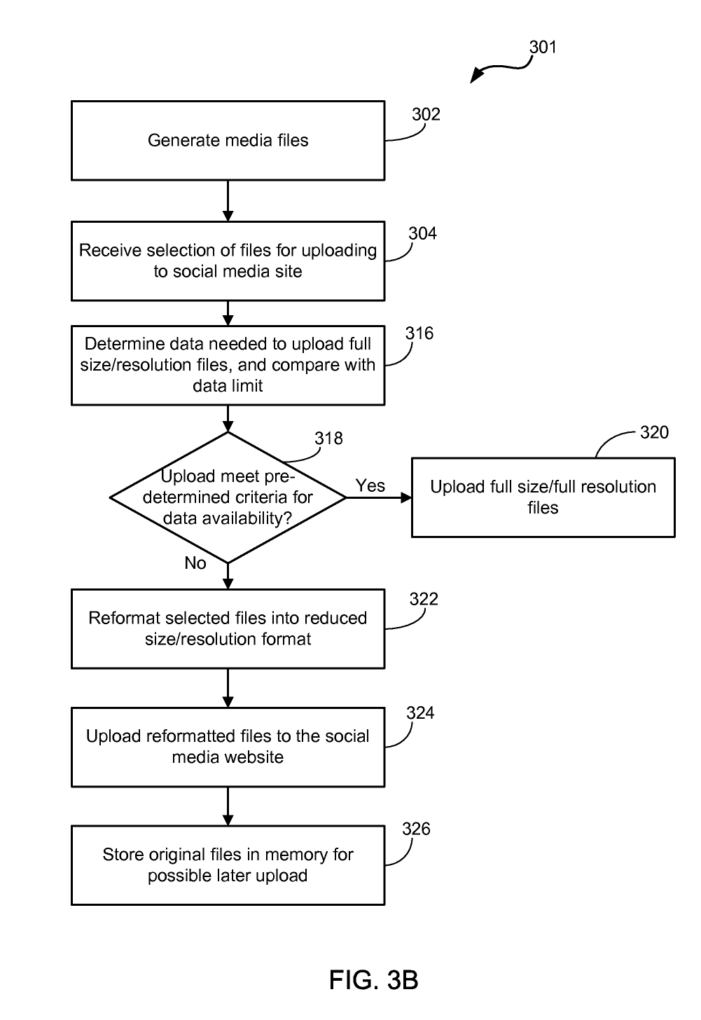

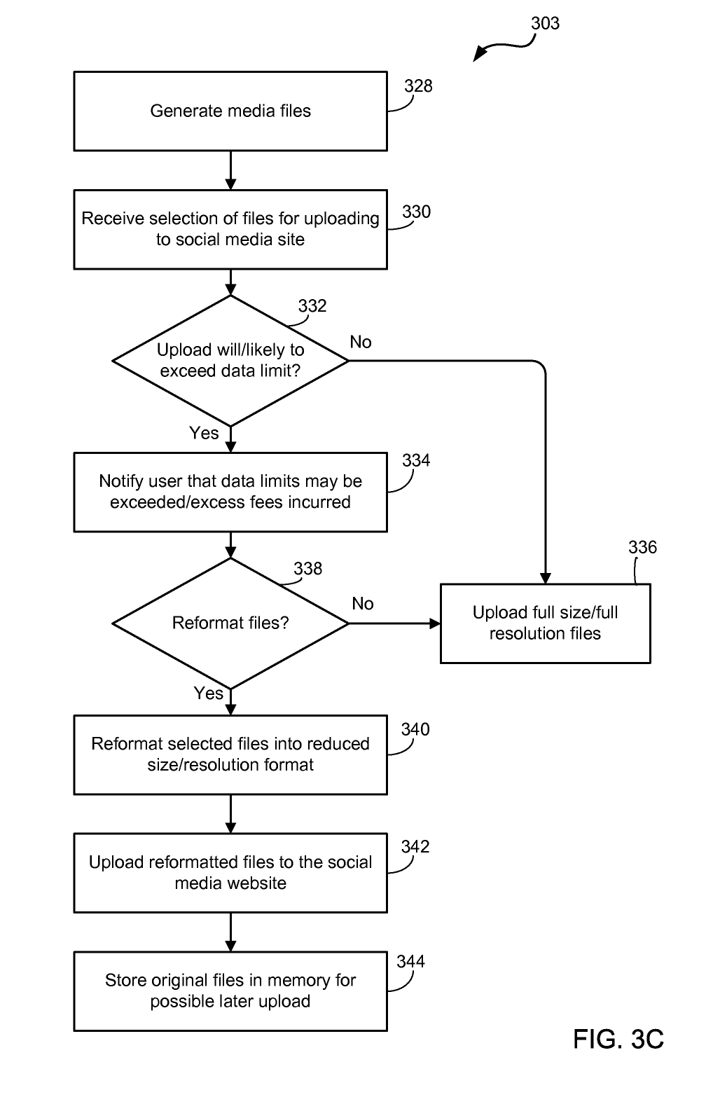

FIGS. 3A-3C illustrate alternative embodiment methods 300, 301, 303 for uploading media files to a social media website from a mobile computing device 106-1. FIG. 3A illustrates an embodiment method 300 in which the mobile computing device 106 automatically reformats media files before uploading the files to a social media website. In block 302, the mobile computing device 106 may generate a plurality of media files, such as picture or video files taken with a camera phone. In block 304, the mobile computing device 106 may receive the user's selection of one or more files for uploading to a social media website, which may be in response to inputs from the user of the mobile computing device. In block 306, the selected files may be reformatted into a reduced size and/or reduced resolution format, and in block 308 the selected files are uploaded to the social media website. In block 310, the mobile computing device 106 may store the original, non-reformatted versions of the files in memory for possible later upload.

FIG. 3B illustrates an alternative embodiment method 301 in which the mobile computing device 106 may use program logic to determine whether to upload a high-resolution or a lower-resolution version of a media file. In this method 301, in blocks 302 and 304, respectively, the mobile computing device 106 may generate media files and receive a selection of files for upload to a social media website, as previously described. In block 316, the amount of data (e.g., megabytes) needed to upload the full-size and/or full-resolution files may be determined, and this data may be compared with an available amount of data in the user's data plan. At determination block 318, the mobile computing device may determine whether the upload of the higher-resolution versions of the files meets pre-determined criteria regarding file transmission formats. In one embodiment, the criteria may simply be whether there is enough data remaining in the user's data plan to allow the upload of the full resolution files without exceeding data usage limits. Other factors may be considered in the pre-determined criteria, such as the user's rate of data usage historically and/or within the current billing cycle compared to limits of the user's data plan, as well as how many days remain until the applicable data usage limits are reset. For example, as part of determination block 318 the mobile computing device may employ an algorithm to determine whether the user is likely to exceed a data usage limit during the current billing cycle if the full size/resolution files are uploaded. The criteria may be fully user adjustable.

If the upload does meet the predetermined criteria for full size and/or full resolution upload (i.e., determination block 318=“Yes”), in block 320 the higher-resolution files may be uploaded to the social media website.

However, where the upload does not meet the criteria (i.e., determination block 318=“No”), in block 322 the files may be reformatted into reduced size and/or reduced resolution format, and in block 324 the reformatted files may be uploaded to the social media website. In block 326, the original files may be stored on the mobile computing device for possible later upload. In embodiments, the mobile computing device 106 may select a suitable format (e.g., size and/or resolution) for the uploaded files based on an available amount of data use for the upload.

FIG. 3C illustrates a further embodiment method 303 in which the mobile computing device 106 notifies the user when a proposed upload may exceed data usage limits and enables the user to decide whether to upload higher- or lower-resolution versions of the files. In this method 303, in blocks 302 and 304, respectively, the mobile computing device 106 may generate media files and receive the user's selection of files for upload to a social media website, as previously described. In determination block 332, the computing device processor may determine whether the upload of the higher-resolution version of the files will or is likely to cause the user to exceed applicable limits for data usage. As discussed above in connection with FIG. 3B, this determination may be a simple comparison between the size of the upload and the data remaining in the user's plan, or it may utilize more sophisticated algorithms to determine the likelihood of the user exceeding the data limit in a given billing period. If the device processor determines that the upload will not cause the user to exceed the data limit (i.e., determination block 332=“No”), the higher-resolution files may be uploaded to the social media website in block 336.

If the processor determines that the upload is likely to cause the user to exceed the data limit (i.e., determination block 332=“Yes”), in block 334 the mobile computing device 106 may notify the user that uploading the selected files may exceed the data limit and result in overage fees. This notification may be in the form of a visual, audio and/or haptic prompt to the user, and may be, for instance, a pop-up appearing on the screen or an icon on the social media application. The notice may include information about the size of the files being uploaded, the data remaining in the user's data, and/or the costs associated with exceeding the data plan limit.

At determination block 338, the computing device processor may present the user with an option to reformat the files, and may receive the user's selection input. If the processor receives an input indicated the user decided not to reformat the files (i.e., determination block 338=“No”), in block 336 the original higher-resolution files may be uploaded to the social media website. If the processor receives an input indicated the user decided to reformat the files (i.e., determination block 338=“Yes”), in block 340 the files may be reformatted into reduced size and/or reduced resolution format, and in block 342 the reformatted files may be uploaded to the social media website. In block 344, the original files may be stored on the mobile computing device for possible later upload.

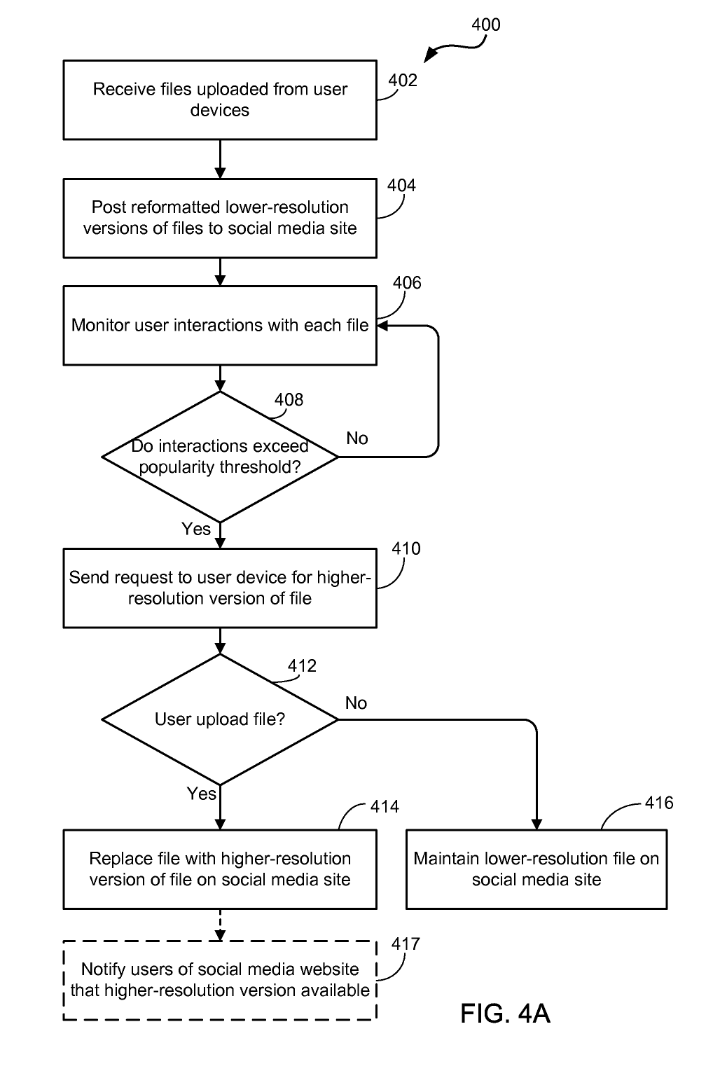

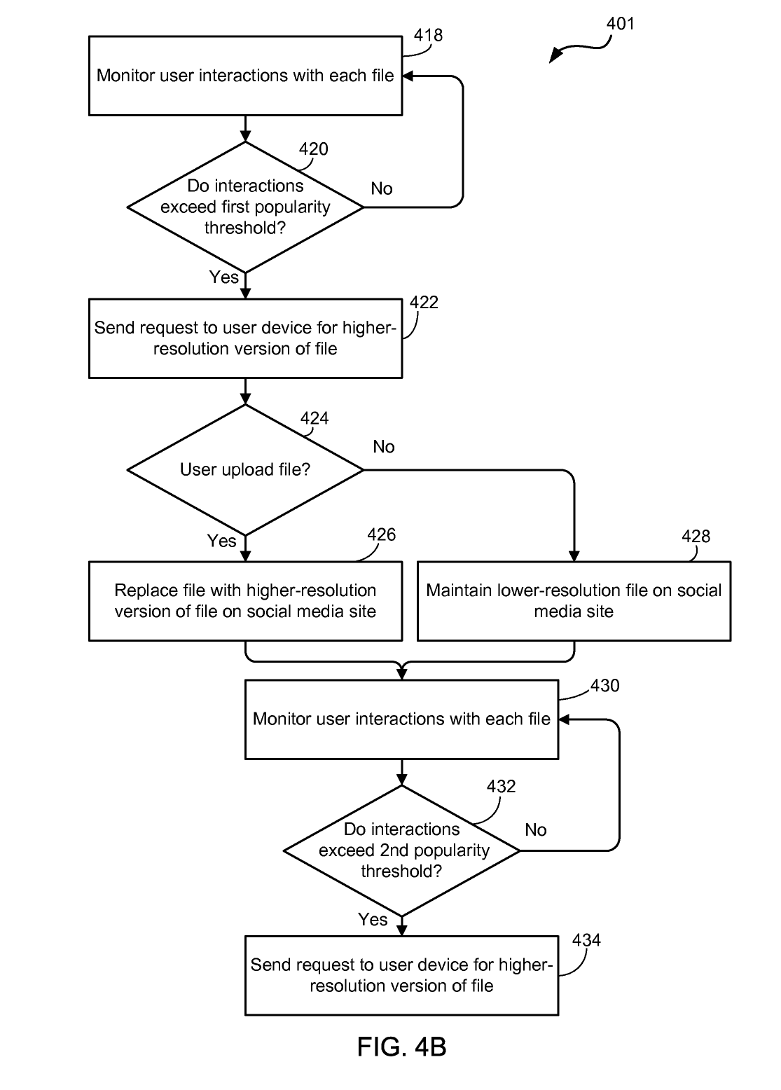

FIG. 4A illustrates an embodiment method 400 that may be implemented on a server for posting media files to a social media website. In block 402, the server 104 may receive files uploaded from one or more user mobile computing devices 106. The files may be uploaded in reduced format in accordance with the embodiment methods previously described in connection with FIGS. 3A-3C, for example. The files may be higher-resolution files that may be reformatted to smaller and/or lower-resolution format by the server 104. This reformatting may be performed, for example, in order to conserve data storage and transmission requirements of the server 104.

In block 404, the received lower-resolution files may be posted to the social media website. In one embodiment, the files may be hosted on a social media server 104, and posted to a website that is associated with one or more users of the social media network, such as a user's Facebook® page. The website may be visited by other users of the social media network, and the server 104 may restrict access to others within the user's approved community (e.g., “friends”). In other embodiments, the user's website may be generally available to the public.

In block 406, the server 104 may monitor interactions with each file. Visitors to the user's website may have various interactions with the media files posted on the website. An interaction with the media file may include clicking-on or requesting to view a particular file, such as a picture or video. An interaction may also include posting a rating of the file (e.g., indicating the viewer “likes” the file), posting a tag of the file, posting a comment regarding the file, linking to the file to the viewer's own page, forwarding the file to other users, etc. In general, the number and types of interactions with a particular media file may indicate the “popularity” of the file within a community of users.

At determination block 408, the server 104 may determine whether interactions with a particular file exceed a popularity threshold. In general, the server 104 may assess the number and/or types of interactions with a file to determine whether the file exceeds a popularity threshold. In one embodiment, the server 104 may simply count the number of views of a file, with the popularity threshold is met when the file has been viewed a predetermined number of times. In other embodiments, the server 104 may factor in other types of interactions, such as the number of tags, comments and/or reviews (e.g., “likes”) received by the file to assess the popularity of the file. The popularity threshold may be a cumulative combination of different types of interactions with the file. The popularity threshold may be server-defined. In other embodiments, the popularity threshold may be defined by the user (e.g., as a control setting on the user's social media website or during upload of the files to the server 104). When the popularity threshold has not been met (i.e., determination bock 408=“No”), the server 104 may continue to monitor the user interactions.

In embodiments, the popularity threshold may be based in part on the popularity of previous files uploaded by the user. For example, users with a history of more frequent likes or interest hits for their media files may, depending on an image quality to bandwidth ratio algorithm, have their media files automatically uploaded at a higher or full resolution.

Once the popularity threshold is met (i.e., determination block 408=“Yes”), then the server 104 may send a request to the user's mobile computing device 106 for a higher-resolution version of the file. The request to the user's mobile computing device can be made in a variety of ways, as discussed above in connection with FIG. 2.

At determination block 412, the server 104 may determine whether the user's computing device has uploaded a higher-resolution version of the file. If the user's computing device does not upload a higher-resolution version (i.e., determination block 412=“No”), the server 104 may maintain the lower resolution file on the social media website (block 416). If the user's computing device does upload a higher-resolution version of the file (i.e., determination block 412=“Yes”), the server 104 may replace the existing file with the higher-resolution version of the file in block 414. In embodiments, the social media server 104 may optionally notify computing devices of users of the social media website that a higher-resolution version of a particular file is available in optional block 417.

FIG. 4B illustrates a further embodiment method in which a plurality of different popularity thresholds may be defined, and the server 104 may send requests for higher-resolution versions of the files to the originating mobile computing device whenever a popularity threshold is exceeded. In block 418, the server 104 may monitor user interactions with each file and at determination block 420 determine whether a first popularity threshold has been exceeded. If the first popularity threshold is exceeded (i.e., determination block 420=“Yes”), the server 104 may request a higher-resolution version of the file in block 422. Depending on whether the user's computing device uploads the file (determination block 424), the server 104 may either replace the file with the higher-resolution version in block 426 (i.e., if determination block=“Yes”) or maintain the lower resolution file in block 428 (i.e., if determination block=“No”). In either case, in block 430 the server 104 may continue to monitor the interactions with each file. At determination block 432, the server 104 may determine whether the user interactions exceed a second popularity threshold for the relevant file(s). The second popularity threshold may be a greater number of interactions with the file (e.g., views, comments, “likes,” etc.) compared to the first threshold. It may be the case, for example, that the user's mobile computing device 106 will not upload a higher-resolution version of a file, or may only upload an intermediate-resolution version of a file, when the file exceeds a first (e.g., lower) threshold of popularity, but will upload a higher-resolution of the file when the file exceeds a second (e.g., higher) threshold of popularity on the social media website. The second popularity threshold may be server-defined or user-defined. When the interactions exceed the second popularity threshold (i.e., determination block 432=“Yes”), in block 434 the server 104 may send a request to the user's mobile computing device 106 for a higher-resolution version of the file than is currently uploaded on the user's social media website. This process may continue with subsequent (e.g., third, fourth, etc.) defined popularity thresholds until all defined popularity thresholds have been met, and/or the server 104 has received the highest-resolution version of the relevant file that is available.

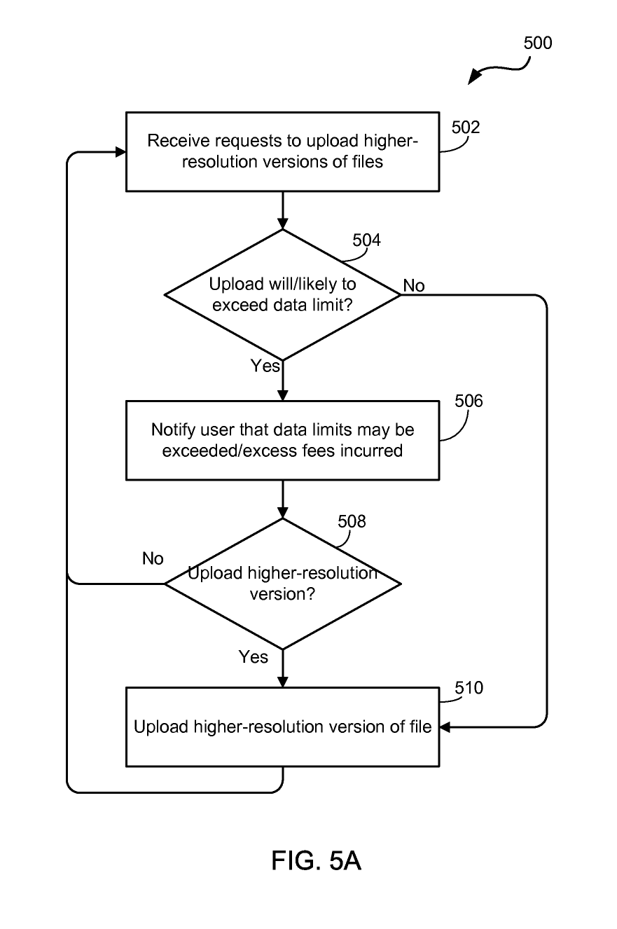

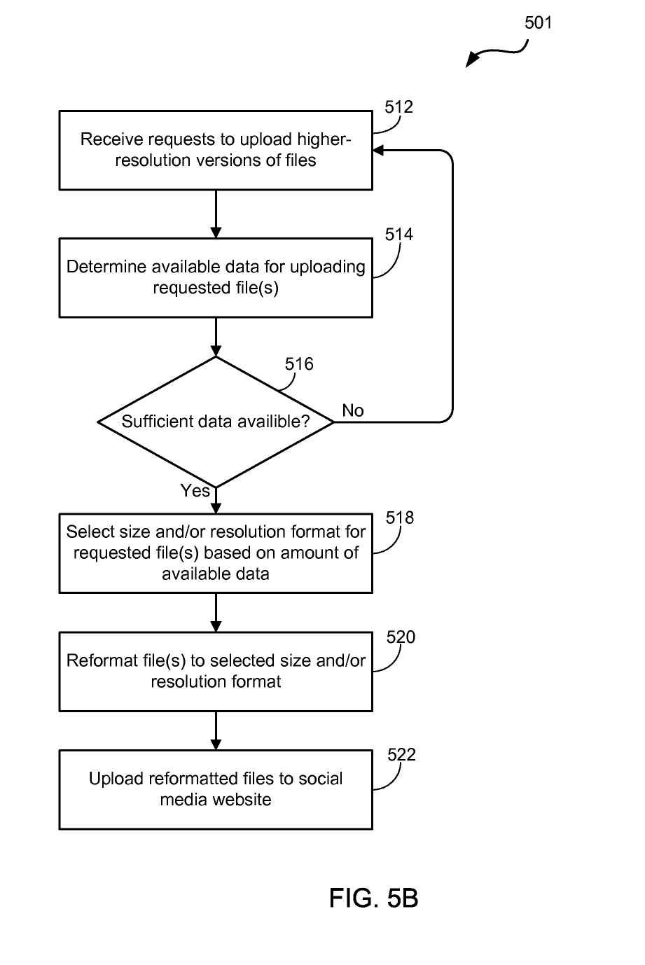

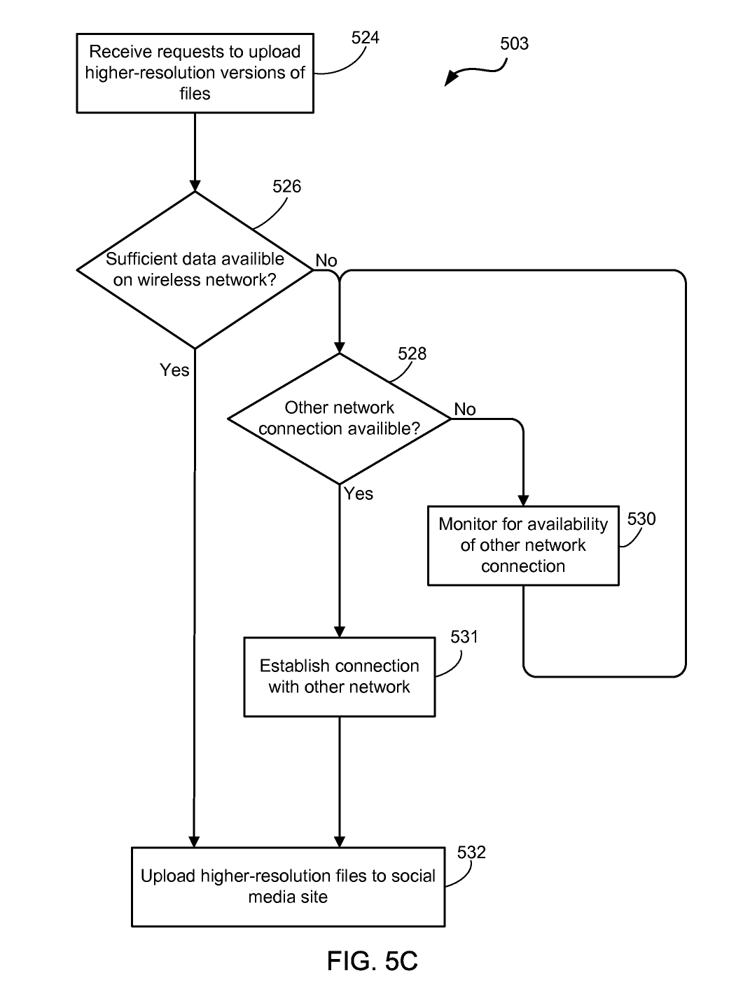

FIGS. 5A-5C illustrate embodiment methods 500, 501, 503 for uploading higher-resolution versions of files to a social media website from a mobile computing device 106. The embodiment methods 500, 501, 503 may be implemented by a computing device processor in response to a request from a social media server 104 to upload a higher-resolution of a file previously uploaded in a lower-resolution format. The request from the social media server 104 may be in accordance with the embodiment methods previously described in connection with FIGS. 4A and 4B. In other embodiments, the methods 500, 501, 503 may be implemented by the device processor in response to a request from another mobile computing device or process, such as from another mobile computing device 106-2, 106-3.

In a first embodiment method 500 illustrated in FIG. 5A, the mobile computing device 106 may receive requests from a social media server 104 to upload higher-resolution versions of files in block 502. At determination block 504, the mobile computing device processor may determine whether a requested upload will or is likely to cause the mobile computing device to exceed a data use limit. As discussed above in connection with FIGS. 3B and 3C, this determination may be a simple comparison between the size of the upload and the data remaining in the user's plan, or it may utilize more sophisticated algorithms to determine the likelihood of the user exceeding the data limit in a given billing period. If the processor determines that the upload will not cause the user to exceed the data limit (i.e., determination block 504=“No”), the higher-resolution files may be uploaded to the social media website in block 510.

If the processor determines that the upload is likely to cause the user to exceed the data limit (i.e., determination block 504=“Yes”), then in block 506 the mobile computing device 106 may notify the user that uploading the selected files may exceed the data limit and result in overage fees. This notification may be in the form of a visual, audio and/or haptic prompt to the user, and may be, for instance, a pop-up appearing on the screen or an icon on the social media application. The notice may include information about the size of the files being uploaded, the data remaining in the user's data, and/or the costs associated with exceeding the data plan limits.

At determination block 508, the device processor may present a prompt providing the user with a choice regarding reformatting the files and receive a user input in response. If the received user input indicates that the user does want to upload higher resolution versions of one or more files (i.e., determination block 508=“Yes”), in block 510 higher-resolution versions of one or more files may be uploaded over network 102 to social media server 104. If the received user input indicates that the user does not want to upload the higher-resolution versions of the requested files (i.e., determination block 508=“No”), in block 502 the mobile computing device 106 may await the receipt of further upload requests.

FIG. 5B illustrates a further embodiment method 501 in which the mobile computing device processor determines how much data (e.g., megabytes) are available for uploading higher-resolution versions of file(s) requested by the social media server 102, and reformats the file(s) to a suitable size/resolution based on the data availability. In block 512, the mobile computing device 106 may receive requests to upload higher-resolution versions of files from a social media server 104, and in block 514 the device processor may determine the amount of data available for use in uploading the requested files. In determination block 516, the mobile computing device processor may determine whether there is sufficient data remaining in the user's data plan to allow the upload of the files in any higher resolution format without exceeding data usage limits. If the processor determines that there is insufficient remaining data usage margin remaining in the user's data plan (e.g., determination block 516=“No”), no files may be uploaded and the processor may await further requests in block 512. If the processor determines that there is sufficient data usage remaining in the user's data plan to enable the upload (i.e., determination block 516=“Yes”), the processor may select a suitable size and/or resolution format in which to upload the requested files in block 518. For example, where the user has a large amount of data usage available and is not likely to exceed an applicable data use limit, the processor may select a very high-resolution format, such as the original file format, for uploading the file. In other cases where the user has less available data usage, the processor may instead select an intermediate format (i.e., one that is higher-resolution compared to the originally uploaded file, but of lower resolution relative to the original file format). In one embodiment, the device processor may select the format based on both the amount of available data usage and the received indication of “popularity” of each file. Thus, for example, the most popular files may be reformatted to a higher-resolution format, and less popular files may be reformatted to an intermediate-resolution format, or not reformatted at all. In block 520, the processor may reformat the file(s) to the selected format(s), and in block 522 the processor may upload the reformatted file(s) to the social media website.

FIG. 5C illustrates a further embodiment method 503 in which the mobile computing device processor may search for an alternative network or communication path, such as a Wi-Fi network connection or wait to up load the file when wireless charges may be less, such as during an off-peak data availability in the primary wireless network, to use to upload requested higher-resolution versions of media files when there is currently insufficient capacity on the primary wireless network. In block 524, the processor may receive requests to upload higher-resolution versions of files from a social media server 104, and in determination block 526, the processor may determine whether there is sufficient data usage remaining in the user's data plan to allow higher-resolution versions of the files to be uploaded over a wireless network 102. When the processor determines that there is sufficient available data usage in the user's data plan (i.e., determination block 526=“Yes”), the processor may upload higher-resolution versions of the files in a usual manner in block 532.

When the processor determines that there is insufficient data usage remaining in the user's data plan (i.e., determination block 526=“No”), in determination block 528, the processor may determine whether there is another network connection available for uploading higher-resolution versions of the requested files. In an embodiment, the other network connection may be a Wi-Fi connection to a communication network, such as the Internet 112. Other connections may include, for example, a Bluetooth®, IEEE 1394, Ethernet or USB connection to a network with access to the Internet. The other network connection may include an off-peak data period (e.g., late night or weekend) in the primary wireless network with cheaper data transfer rates. An advantage of this type of connection is that it may not be subject to the same data transfer limitations as a cellular wireless network 102 (e.g., 3G or 4G network). A potential drawback of this type of connection is that may only be available intermittently, such as when the mobile computing device 106 is located within a Wi-Fi “hotspot.” If the processor determines that it does have access to another network connection (i.e., determination block 528=“Yes”), such as when the mobile computing device is in a Wi-Fi “hotspot,” then the processor may establish a connection with the other network if it has not already done so, in block 531. The processor may then use this established other network connection to upload higher-resolution versions of the files in block 532. When the processor determines that no other connection is available (i.e., determination block 528=“No”), the processor may wait until such a connection becomes available by monitoring for the availability of a network connection in block 530.

In one embodiment, the device processor may upload higher-resolution versions of files based on various combinations of rules. For example, the device processor may be set to upload requested high-resolution versions of files only when the file meets a particular popularity threshold, such as described above in connection with FIGS. 4A and 4B, and when the mobile computing device has access to a Wi-Fi network. In a further embodiment, the processor may be configured to wait until there is sufficient data usage available within the user's data plan on the cellular wireless network 102 (e.g., when data use limit resets at the start of a new billing period) before uploading the requested high-resolution versions of files.

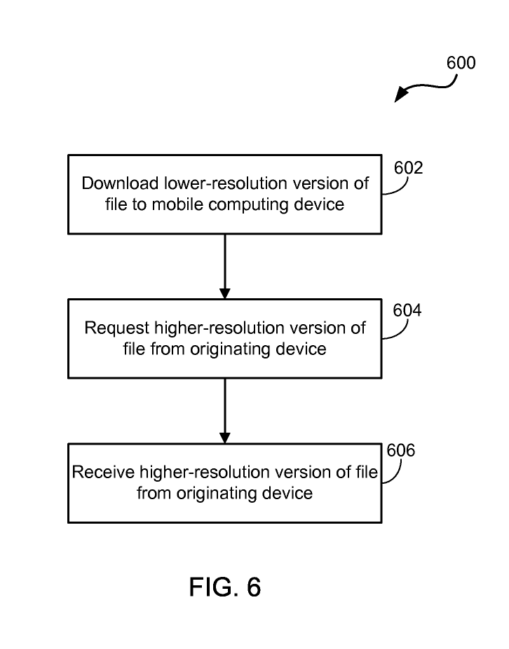

FIG. 6 illustrates an embodiment method 600 in which a mobile computing device 106 of a second user, who may be a friend or associate of the originating user, sends a request for a higher-resolution version of a file posted on a social media website to the originating user's mobile computing device 106. The originating user may have previously uploaded the media file to a social network server 104 using any of the embodiment methods described herein. In block 602 of method 600, the second user's mobile computing device 106-2 may download a lower-resolution version of a media file. The user's device 106-2 may download the media file by visiting a social media website associated with the originating user, and the file may downloaded from social media server 104 in a usual manner. In method 600, instead of the server 104 requesting a higher-resolution version of the image as described above for other embodiments, the second user's computing device 106-2 may send a request directly to the originating mobile computing device 106 in block 604 through a communication channel, such as e-mail, SMS, a TCP/IP link, etc. The originating user's social media page or the file itself may include the necessary addressing to enable this communication to happen. In response to such a direct request, the originating user's computing device may transmit a higher resolution version of the file through an available communication channel. The transmitted file may be received by the second user's mobile computing device 106-2 in block 606. The originating user's computing device may transmit the higher-resolution version using any of the embodiment methods described herein, and may, for example, upload the file to the social network server 104 from which it may be downloaded by mobile computing device 106-2. In alternative embodiments, the originating user's computing device may transmit the file over a direct communication link between the originating mobile computing device 106 and the mobile computing device 106-2 of the requesting user.

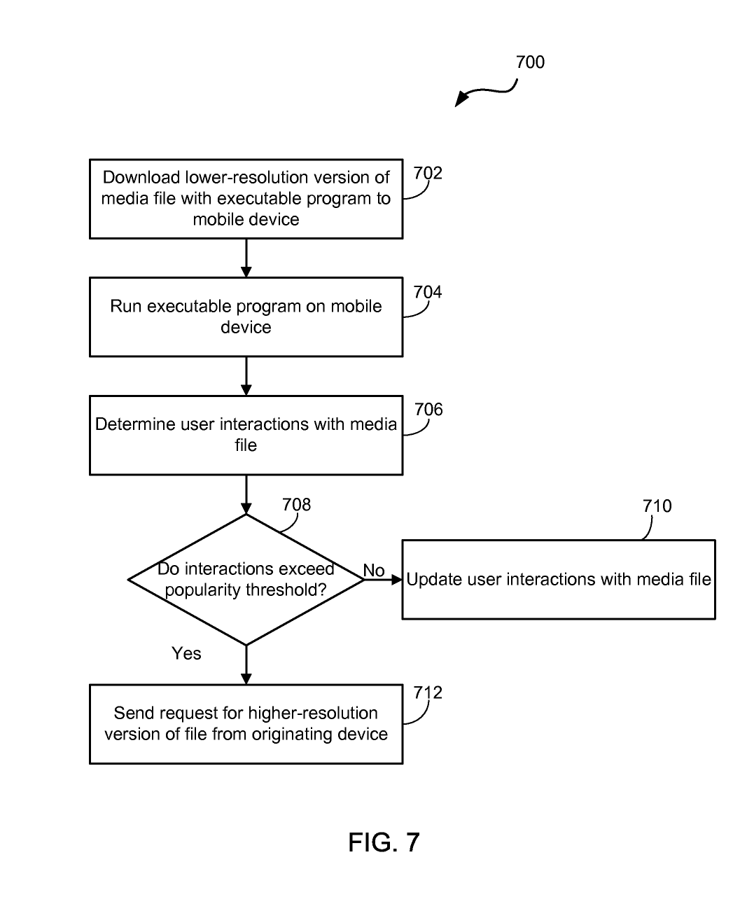

FIG. 7 illustrates an embodiment method 700 in which uploaded media files are configured with an executable program which may be embedded in the media file or which may be the file itself when the file is configure to generate the media when executed. The executable program may be configured to cause a server or a receiving computing device to send a request for a higher resolution version of the media file. According to this embodiment, instead of the server 104 being configured to determine that a higher resolution image is requested, the media file itself may be or may have embedded within it an executable program, such as an XML file or Java® applet, so that when a computing device accesses the media file from a server, the access downloads the executable program. The executable program may be configured to cause a computing device to communicate with the originating computing device to request a higher resolution image. This media file executable program may be created by the originating user's mobile computing device and uploaded to the social media server as part of the file upload process. In other embodiments, the media file executable program may be created by the social media server 104 when the file is posted to the social media website.

In method 700 in block 702, a mobile computing device 106-2 may download a lower-resolution version of a media file with embedded executable program from a social media server 104. In block 704, the executable program may run on the receiving computing device 106-2 once the file is downloaded. In an embodiment, the executable program may include much of the functionality previously described in connection with the social media server 104. For example, the executable program may include a counter that tracks the number of times the particular media file is downloaded or viewed, and may also track user interactions with the media file (e.g., tags, comments, “likes,” etc.). In block 706, the executable program may cause the computing device 106-2 to determine user interactions with the media file, including prior interactions from other users as well as any current interactions by user of the mobile computing device.

In determination block 708, the computing device executing the executable program may determine whether the total user interactions exceed a popularity threshold, such as described above in connection with FIGS. 4A and 4B. When the user interactions exceed the popularity threshold (e.g., determination block 708=“Yes”), the executable program may cause the mobile computing device 106-2 to send a request for a higher-resolution version of the media file. In some embodiments, the request may be sent directly to the originating mobile computing device via a suitable communication path, such as e-mail, SMS message, etc. In other embodiments, the request may be sent to the social network server which may be configured to relay the request to the originating computing device, such as via e-mail, SMS, HTML, or the next time the computing device logs onto the server. In response to receiving a request for a higher resolution file, the originating computing device 106 may transmit a higher-resolution version of the file directly to computing device 106-2 or to the social media server for relay to the requesting computing device. In some embodiments, the social media network may operate as a distributed or peer-to-peer-type system.

In other embodiments, in response to a request from a computing device 106-2, the originating computing device 106 may upload the higher-resolution version of the file to social media server 104, and the server 104 may download the higher-resolution version to all other computing devices requesting the file, including the requesting computing device 106-2.

In some embodiments, the request for a higher-resolution version of the file (block 712) may be sent by the computing device 106-2 to the social media server 104. The social media server 104 may transmit a request to the originating mobile computing device 106 to upload the higher-resolution version of the file, and once uploaded, the server 104 may download the higher-resolution version to other mobile computing devices, including the requesting computing device 106-2.

If the user interactions do not exceed the popularity threshold (e.g., determination block 708=“No”), the executable program may cause the computing device receiving the file to update the user interactions with the file in block 710. For example, the executable program may cause the computing device receiving the file to increment a counter or other tracking function to record each interaction with the file. This count may be maintained on a central database, such as the social media server, which may be accessed via normal Internet interactions between the computing device and the server. In this way a cumulative record of the file's popularity threshold may be maintained. In such embodiments, the executable program may cause the computing device receiving the file to transmit updated user interactions to the social media server 104, so that when a subsequent user downloads the media file, the executable program running on that user's mobile computing device will have an accurate and up-to-date indication of user interactions with the file.

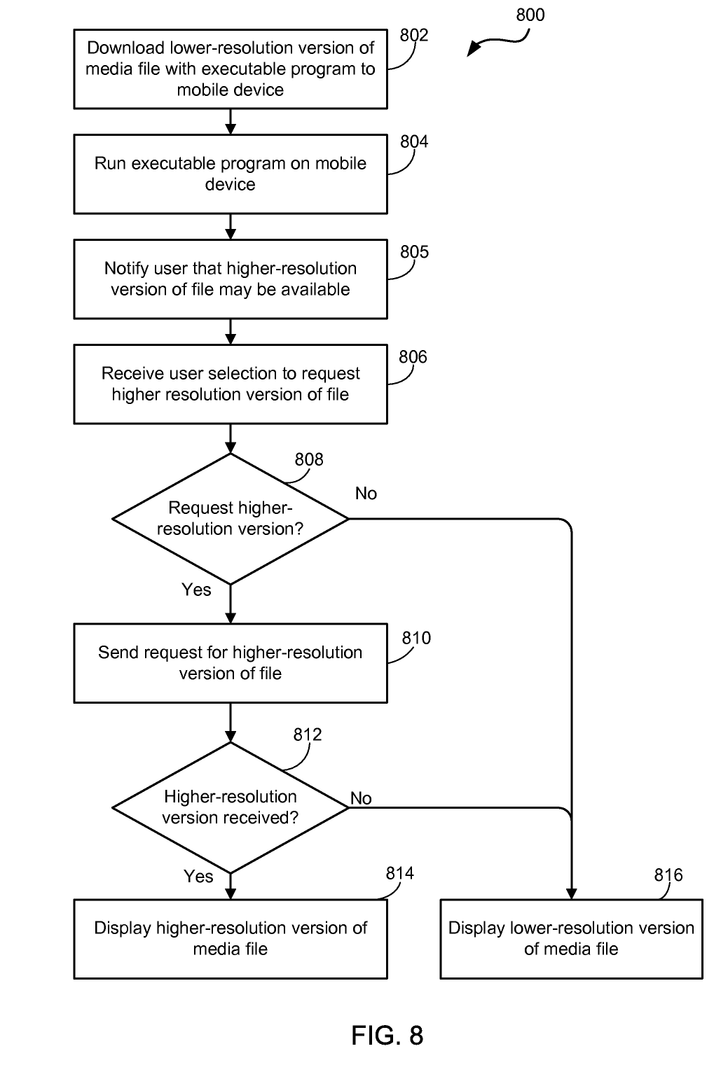

FIG. 8 illustrates an alternative embodiment method 800, similar to method 700 described above. In this method 800, after the computing device 106-2 downloads a media file (block 802) and runs the executable program embedded within the file (block 804), the user of that mobile computing device 106-2 may be notified that a higher-resolution version of the downloaded file may be available in block 805. The user may provide an input to the computing device indicating whether the user desires to receive the higher resolution version of the downloaded file. The user's input may be received in block 806 and assessed by the computing device in determination block 808. If the user input indicates a desire to receive a higher-resolution version (i.e., determination block 808=“Yes”), in block 810, the executable program may cause the computing device 106-2 to send a request for a higher-resolution version of the media file, such as using methods discussed above in connection with method 700. If the higher-resolution version of the file is received (i.e., determination block 812=“Yes”), that version of the file may be displayed in block 814. Otherwise (i.e., determination block 808 or 812=“No”), the lower resolution version of the file may be displayed in block 814.

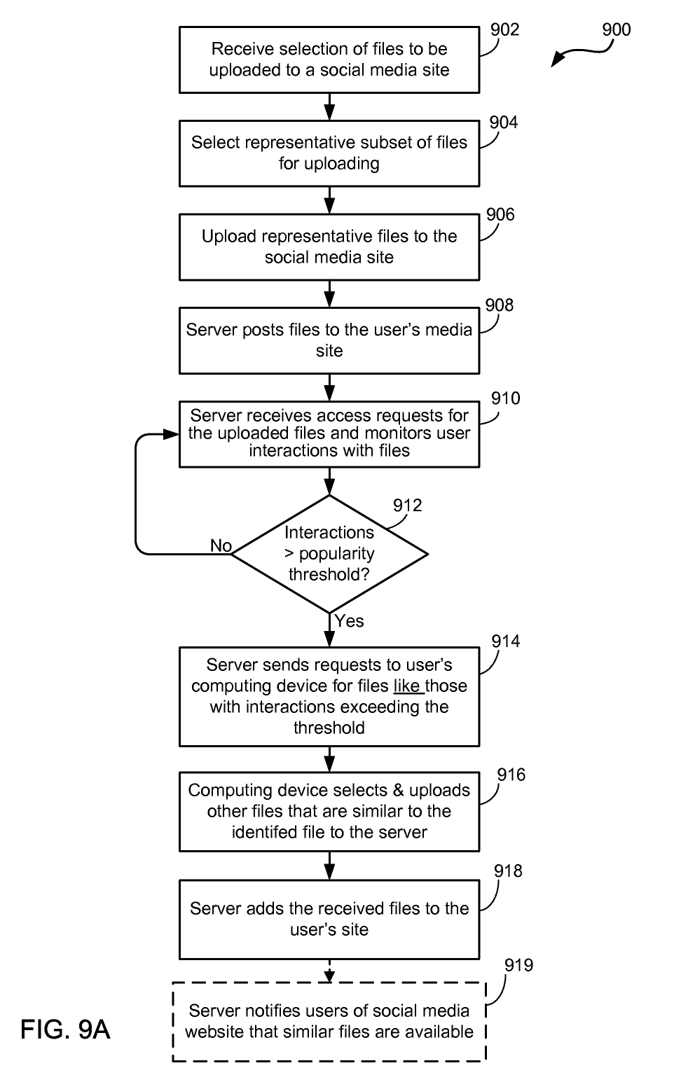

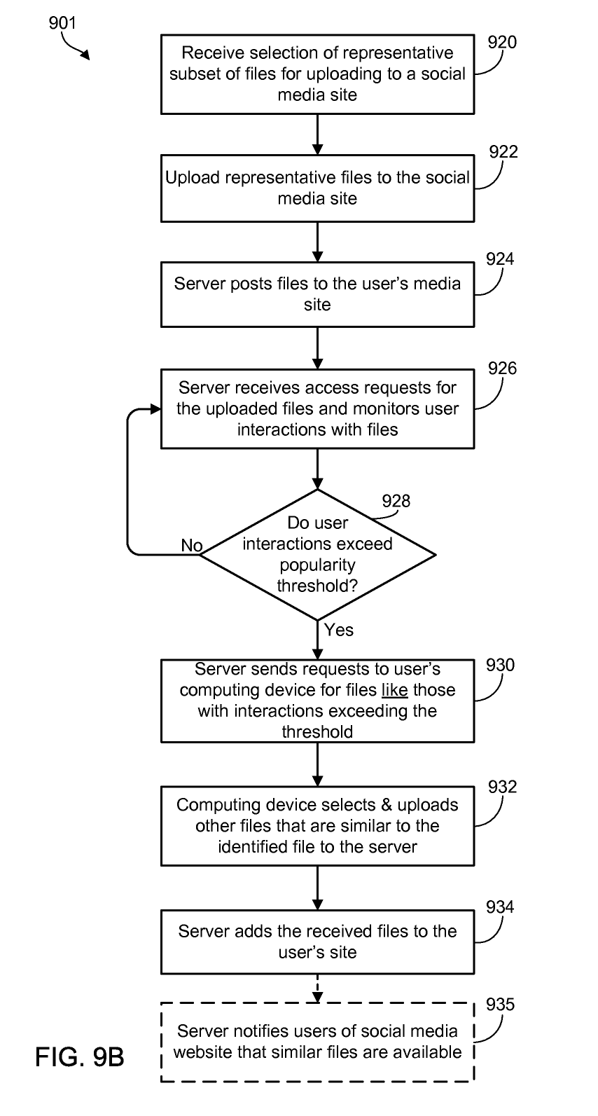

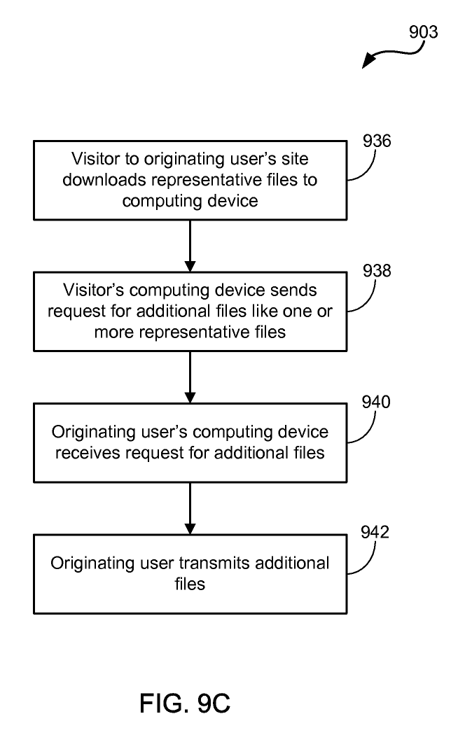

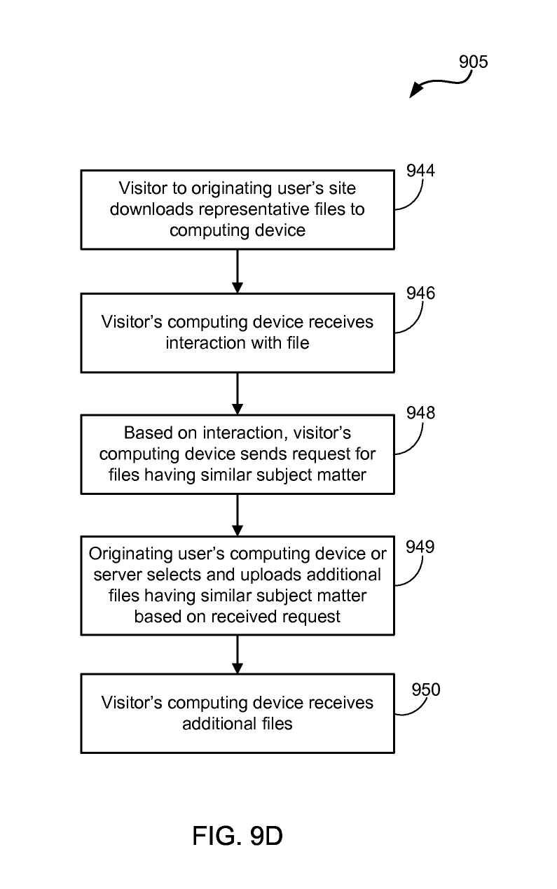

FIGS. 9A and 9B illustrate further embodiment methods 900, 901 for uploading media files, such as photographs or video files, to a social media website. In these embodiments, rather than (or in addition to) adjusting the file size or format, a subset of selected files are uploaded, saving the user's data plan usage by reducing the number of files uploaded. Later, popular types of files may be uploaded in response to requests feedback from friends and social media associates. In methods 900, 901, a user's mobile computing device 106 may upload a representative subset of media files to social media server 104. Based on the popularity (e.g., number of views, hits, interactions, etc.) of one or more of the representative files, the social media server 104 may request that the user's mobile computing device to upload 106 additional media files. In particular, the social media server 104 may request that the user upload files that are similar to one or more popular file(s) in the previously-uploaded representative subset. In response, one or more similar files, which may be selected by the user's mobile computing device 106 and/or the social media server 104 using a variety of algorithms, may be uploaded to the user's social media website. In some embodiments, this method 900 may enable the user to reduce the bandwidth or data transmission requirements for an initial upload of media files, while the user's data plan may be more efficiently used to upload files that share one or more features with known popular files, and are thus likely to be of real interest to friends and associates. The embodiment methods 900, 901 may be used as an alternative to, or in addition do, methods in which the media files initially uploaded to a social media website may be downsized or compressed versions of the files, such as the embodiment methods previously described herein.

In block 902 of method 900, the mobile computing device processor may receive selections of media files (e.g., photographs, video files, etc.) to be uploaded to a social media website in the form of a sequence of user inputs on a user interface. For example, the user may have recently been on a vacation, and the received user inputs may select a set of files (e.g., pictures, videos, etc.) pertaining to the vacation for upload to the user's social media website.

In block 904, the user's mobile computing device processor may select a representative subset of files to upload to the social media website, and in block 906, the processor may upload the representative files as described above. The selection may be made by the processor executing application software. A variety of algorithms may be used for selecting representative files, such as selecting a limited number of photos that includes faces (e.g., using a facial recognition algorithm), a limited number that include rectilinear features as might be seen in architectural photographs, and images including fractal features as would be the case in landscape photographs. The representative files may also be selected based on timestamps and/or global positioning satellite (GPS) coordinate data associated with the files. In the case of audio and/or video files, a representative subset may include portions or partial clips of the full file. In some embodiments, the representative files may be selected based on a predefined pattern (e.g., every fifth file from a set), and may be selected using a random or pseudo-random selection process. In some embodiments, the number and/or size of the representative files may be based at least in part on an amount of available bandwidth or data usage available or remaining in the user's data plan.

In block 908, the social media server 104 may post the representative subset of files to the user's social media website, and in block 910, the server 104 may receive access requests for the uploaded files and monitors user interactions with each file. In determination block 912, the server 104 may determine whether the user interactions with a particular representative file exceeds a popularity threshold. As discussed above, the popularity threshold may be a particular number of views or access requests for a file, and may also be based on other user interactions, such as tags, comments, “likes,” etc. received by a file. The popularity threshold may be user- or server-defined. While the interactions with a file do not exceed the defined popularity threshold (i.e., determination block 912=“No”), the server 104 may continue to receive access requests and monitor interactions in block 910.

When the server determines that interactions with a file exceeds the popularity threshold (i.e., determination block 912=“Yes”), in block 914, the social media server 104 may send a request to the user's mobile computing device 106 for additional media files similar to the popular file. In response to this request message, in block 916, the user's mobile computing device processor may identify other files among those selected by the user which have similar characteristics, and upload them to the social network server 918. The server may receive those additional files and may add the files to the user's website in block 918. In this manner, popular types of images may be uploaded based upon crowd preferences.

The identification and selection of files similar to popular file(s) posted on a user's social media website, as shown in block 916 of FIG. 9A, may be accomplished by the device processor executing application software. A variety of algorithms may be used for selecting similar files. For example, a popular file from the originally-uploaded representative subset may be compared with other files from the set to identify files sharing similar subject matter, timestamp data, GPS location, etc. In the case of photographs, for example, facial and/or other geometric features, colors, metadata (e.g., “tags”), time and location data may be compared to identify files meeting a threshold of similarity. In some cases, files that are the closest matches to a popular file may be selected for upload (e.g., files that are closest in timestamp, GPS location, subject matter, etc.). In other embodiments, the popularity of representative files may be indicative of an overall interest in the set from which the files were taken. In an embodiment, the similar files that are uploaded may be other files from the set that are selected for their diversity relative to the originally-uploaded files. For example, the files selected from the set may be furthest away in timestamp or GPS data, or may include different subject-matter from the files of the representative subset, or may include different file formats (e.g., if an originally uploaded photograph proves popular, a video file having a similar timestamp, location or subject matter may be uploaded). The user's computing device processor and/or the social media server may be configured with settings to prioritize which files or types of files are uploaded.

In various embodiments, the number and/or size of the files uploaded by processor in block 916 may be based in part on an amount of available bandwidth or data usage in the user's data plan. In some instances, such as when the user is at or near a data plan limit, no other files may be uploaded.

In embodiments, the social media server 104 may optionally notify computing devices of users of the social media website that additional files similar to previously-uploaded files are available in optional block 919.

FIG. 9B illustrates an embodiment method 901 that is similar to method 900 shown in FIG. 9A. In this method 901, the user selects representative files to be uploaded to the social media website. In block 920, the user's mobile computing device processor receives the selection of representative files in the form of a series of user inputs, and uploads the files to the social media server in block 922. Blocks 922 through 928 are identical to blocks 906 through 914 described above with reference to FIG. 9A, in which the server 104 posts the files to the user's website, receives access requests and monitors user interactions with the file, and when a file reaches a pre-determined threshold of popularity, sends a request to the user's mobile computing device 106 to upload files that are similar to the popular file. Method 901 differs from method 900 in that in block 930, the user's mobile computing device processor may notify the user that additional files have been requested for upload. In block 932, the user may select and upload additional files by performing a series of inputs in a user interface that the device processor can receive and process. The selected additional files may be posted to the user's social media website by the processor in block 934. In some embodiments, the user's mobile computing device processor may be configured with application software to assist the user in selecting representative files (block 920) and in selecting additional (e.g., similar) files for uploading (block 932). The processor may be configured to identify files which are similar to the identified files for uploading, such as described above in connection with method 900, and display prompts or lists that suggest particular files for uploading. The processor may also notify the user if the upload of additional files will exceed a data plan limit, and if so, any additional costs associated with uploading the files. In embodiments, the social media server 104 may optionally notify computing devices of users of the social media website that additional files similar to previously-uploaded files are available in optional block 435.

FIG. 9C illustrates an embodiment method 903 in which a mobile computing device 106-2 of a user, who may be a friend or associate of the originating user, views one or more representative media files on the originating user's social network website and sends a request for additional media files. The originating user's computing device may have previously uploaded a representative subset of media files to a social network server 104 using embodiment methods 900, 901. In block 936 of method 903, a visitor to the originating user's website may download one or more of the representative files to his or her computing device 106-2. In block 938, the user's computing device 106-2 may send a request for additional files that are like one or more of the representative files. The request for additional files may be sent to the social media server 104 or directly to the originating user's mobile computing device 106 through any suitable communication path.

In various embodiments, the user's computing device 106-2 may be configured to include functionality that prompts the user to request additional files. For example, the computing device may display a prompt asking the user whether he or she would like to see more files that are similar to the representative file(s) being displayed. In various embodiments, the user's computing device 106-2 may be configured to display one or more file request options in response to an interaction with a particular file, such as the user clicking on a “more like this” button over a picture or album. The one or more file request options, which may be presented by computing device 106-2 as pop-up menu options in a user interface, may include different categories of files, such as “more from this day,” “more from this week,” “farthest from this time on the same day,” etc. The user's computing device 106-2 may receive selection input from the user corresponding to the file request options, and send the request for additional files based on the received selection input.

In other embodiments, the request for additional files may be automatically sent based on the user's interactions with one or more representative files (e.g., leaving a comment, clicking “like,” etc.).

In block 940, the mobile computing device 106 of the originating user may receive the request for additional files. In some embodiments, the request may be relayed by the social media server 104. In block 942, the originating mobile computing device processor may select and transmit additional files to the requesting mobile computing device 106-2. The additional files may be selected based on file request options from the requesting device 106-2. In some embodiments, the additional files may be uploaded to social media server 104, which may then download the files to other mobile computing devices, including the requesting mobile computing device 106-2.

FIG. 9D illustrates an embodiment method 905 in which the visitor's mobile computing device 106-2 may request files having subject matter similar to one or more representative media files on the originating user's social media website. This method 905 is similar to embodiment method 903 in that a visitor to the originating user's website may download one or more of the representative files to his or her computing device 106-2 in block 944. In block 946, the visitor's computing device 106-2 may detect an interaction with one or more of the files, such as the user clicking on a file or on a portion of a file. For example, the computing device 106-2 may be configured to detect when the user clicks on individual faces in a photograph. Based on the interaction, the visitor's computing device 106-2 may send a request for additional files having a similar subject matter to either the social media server 104 hosting the originating user's website (e.g., the user's Facebook® page) or directly to the originating user's computing device in block 948. Methods for sending and processing such requests implemented in block 948 may be similar to those of other embodiments described above. For example, when the detected user interaction includes the user clicking on a particular person's face in a photograph, the visitor's computing device 106-2 may send a request for additional photographs of that person to either the social media server 104 hosting the originating user's website or to the originating user's computing device.

The request sent or relayed (i.e., via the social media server 104 hosting the originating user's website) to the originating user's computing device 106-1 in block 948 may identify the files of interest (e.g., a file name or ID) and include sufficient information regarding the visitor's user interaction to enable it to select similar files for uploading and/or sending to the requesting visitor's computer 106-2. For example, if the visitor clicked on a particular face within a photograph, an excerpt of the face may be relayed in the request for more files. As another example, coordinates of the visitor's interaction with a file, such as X and Y coordinates or pixel coordinates within a photograph, or page and line numbers in a text document, may be relayed in the request. In block 949 the originating user's computing device 106-1 may use the relayed information to determine the portion of the identified image that is of interest to the visitor. If the identified file is a photograph, the processing software, such as facial recognition software/algorithms, to identify additional files having similar subject matter (e.g., photographs of a particular person or persons). In an embodiment, the computing device 106-1 may also or alternatively use metadata (e.g., tags) associated with the identified file(s) to select files having similar subject matter.

In other embodiments, in block 949 the server 104 may be configured to identify files having similar subject matter that have been uploaded from computing devices of other users, such as a third user's computing device 106-3. The server 104 may use recognition software and/or metadata to identify such additional files. In some embodiments, as part of operations in block 949 the server 104 may be configured to send a request to one or more other computing devices 106-3 requesting upload of additional files having similar subject matter. For example, when the server 104 receives requests for additional photographs of a particular person, the server may relay the request to other computing devices that are likely to have such additional photographs, such as device(s) used by the person in the photograph and/or computing devices used by that person's friends and family and social media contacts.

When files having similar subject matter have been selected by the originating user's device 106-1, the server 104 and/or by another computing device (e.g., device 106-3), the selected files may be sent to the requesting device 106-2 via any suitable communication path, including uploading to the originating user's social media page or website in block 949. In block 950, the selected files may be received by the visitor's computing device 106-2 either directly from the sender (computing device or server) or by accessing an updated social media site, such as the originating user's social media page or website.

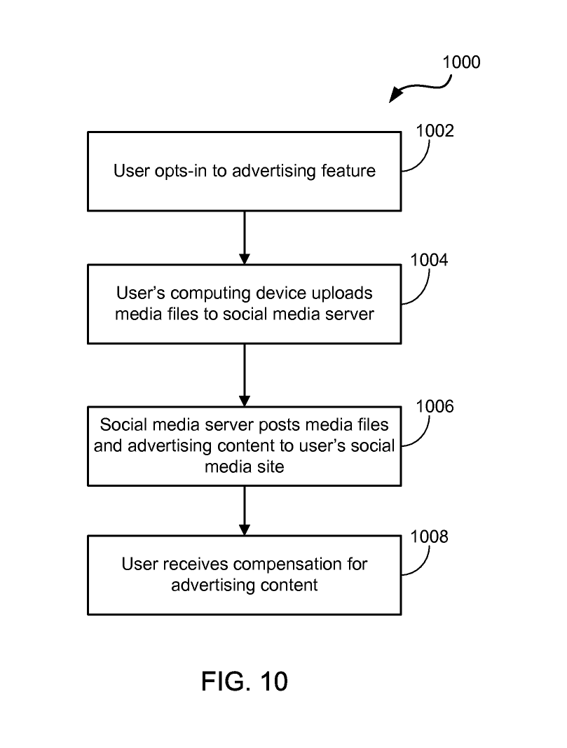

FIG. 10 illustrates an embodiment method 1000 for uploading media files to a social media website in which the user may elect to have advertising content posted on his or her social media website in addition to the media files. In an embodiment, the user may be compensated for including the advertising content within the user's social media page and/or uploaded media files, and the compensation may include part or all of the costs (e.g., data transmission costs) associated with uploading the media files. In block 1002 of method 1000, the user may opt-in to an advertising feature on a social media website using the user's mobile computing device 106. This may involve the user accessing a website and signing up for the service by filling in an electronic form. In block 1004, the user's mobile computing device 106 may upload media files to the social media server 104 using the methods described herein. In block 1006, the social media server may post the media files including the advertising content to the user's social media website. In block 1008, the user may receive compensation for the advertising content, such as in response to each access or interaction with a posted media file. In one embodiment, the advertisers providing the advertising content may compensate the user, and the compensation may include part or all of the user's costs (e.g., data transmission costs) in uploading the files. In an embodiment, the advertising function may be accomplished by executable instructions executing on a processor of the user's mobile computing device that may enable advertisers to send compensation directly to the user's wireless carrier. The amount or value of the compensation received by the user may be based at least in part on the popularity of the uploaded media files, with more popular files being worth higher compensation. For example, the compensation may be provided in the form of free uploads of higher resolution versions of popular files including advertising content and/or additional similar files including advertising content.

In some embodiments, the advertising function may be activated when one or more media files uploaded by the user exceed a popularity threshold. For example, when the number of views or interactions with a particular file reaches a defined popularity threshold, such as previously-described in this application, the social media server 104 or an advertiser may request that the user upload higher-resolution versions of the popular files and/or additional files that are similar to the popular files, with the costs of the upload being shared with or borne by advertisers who may display advertising content in connection with the uploaded media files.

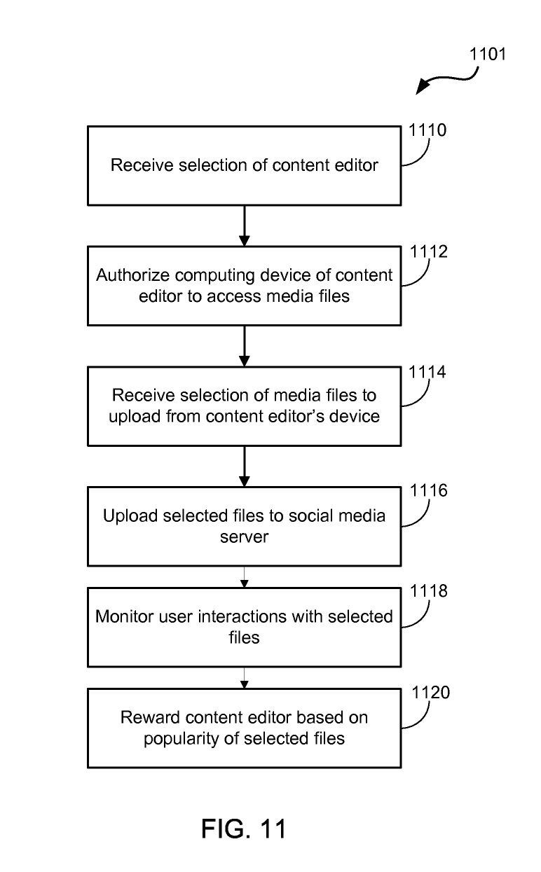

FIG. 11 illustrates an embodiment method 1101 for uploading media files to a social media website in which the user may allow a human agent (or “content editor”) to remotely access the user's device computing device 106-1 and select media files for upload to the social media website. In block 1110, the user's computing device 106-1 may receive a selection of a content editor. The content editor may be any user of the social media website that may be given access to media files stored on the originating user's device 106, and may decide for the “crowd” which media files should be uploaded to the social media website. In some embodiments, the user may provide another person with “content editor” privileges on his/her social media website. The content editor may be someone within the user's social media network (e.g., a “friend”). In some embodiments, the user may select one or more content editors based on the content editor's prior experience in selecting media files for upload. For example, the social media website may provide “content editor” records for a plurality of users of the social media website, based on these user's prior experience in choosing media files for upload, and a user may select one or more of these content editors to edit his/her social media uploads.

In method 1001 in block 1112, the user's computing device 106-1 may authorize a computing device of the selected content editor to access media files stored on the user's device 106-1. The computing device 106-1 may allow the content editor's device to access the media files over a network, such as a cellular wireless network 102 and/or the Internet 112, and may enable communication between the computing devices using socket communication, TCP/IP communication, cellular data communications, etc. In some embodiments, the user's computing device 106-1 may send social media files to the content editor's computing device using a suitable communication path (e.g., SMS, e-mail, etc.). The files may be sent directly to the content editor's computing device or may be relayed by a server 104. In order to minimize bandwidth, the originating user's computing device 106-1 may send reduced resolution versions of the media files to the editor's computing device, such as described above.

In some embodiments, the originating user's computing device 106-1 may receive a user input selection of particular media files stored on the computing device 106-1 which the user does not want uploaded, even though the user has given a content editor permission to access the user's computing device and upload media files to a social media website. The originating user's computing device 106-1 may include functionality to block the content editor from accessing and/or uploading these particular files.

The content editor may review the user's media files on his/her computing device, and select a plurality of files for upload. In block 1114, the user's computing device 106-1 may receive a selection of files from the content editor's computing device. In embodiments, the selection of files may include a portion of a file. For example, if the media file is an audio or video file, the content editor may be able to edit the file down to a select portion of the file. In block 1116, the user's computing device 106-1 may upload the selected files (or file portions) to the social media site.

In block 1118, user interactions with the selected files may be monitored by the social media server 104 and/or the originating user's computing device 106-1. The monitored user interactions may be used to determine how effectively the content editor selected files based on the determined popularity of the files, and thus how well the content editor selected files of interest to the “crowd.” The monitored interactions may be used to rate the content editor's performance, and may be reflected in the editor's content editor records on the social media website. For example, the content editor may receive “points” for each interaction (e.g., click, comment, “like,” etc.) with a media file selected by the content editor. In embodiments, “points” may be earned, for example, based on total interactions for selected files, percentage of selected files receiving an interaction, number of interactions per file selected, etc. The users of the social media site may be able to select the “best” content editors based on the number of points earned. In block 1120, the content editor may receive a reward based on the popularity of the selected files. The reward may be provided by the social media server 104 and/or the originating user's device 106-1. In one embodiment, the reward may be “points” earned for the popularity of selected files, as described above. In other embodiments, the reward may include monetary or other valuable compensation (e.g., coupons or vouchers), particularly in embodiments in which advertisers are permitted to place ads on content posted by users.

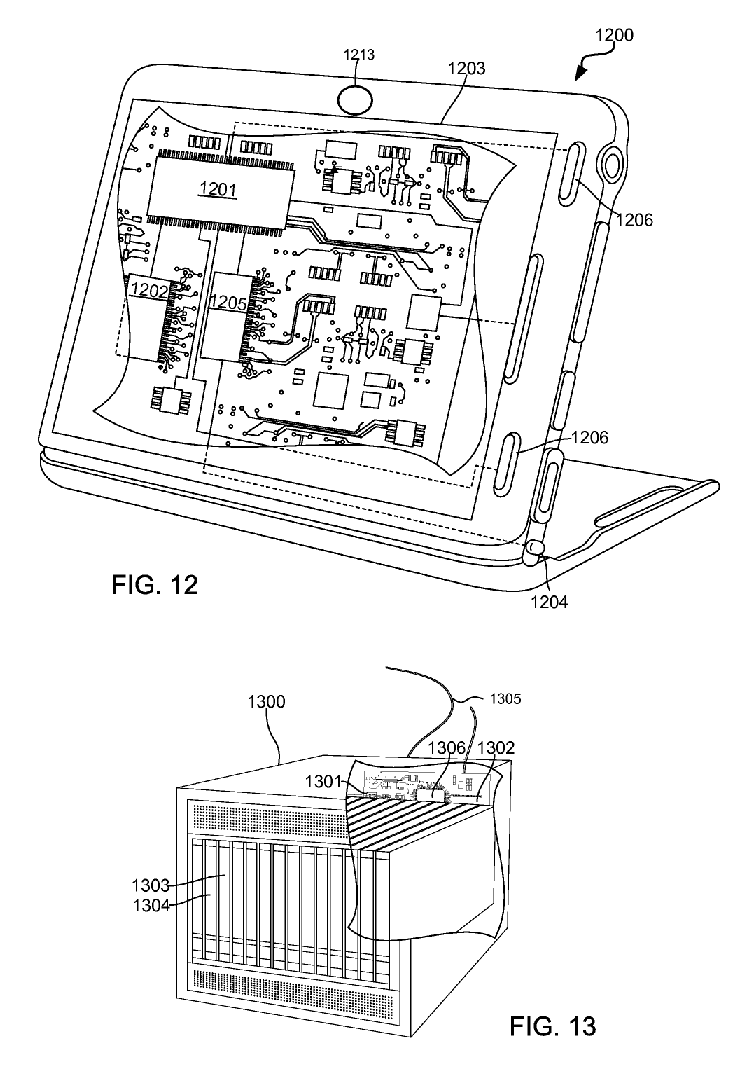

Various embodiments may be implemented in a variety of mobile computing devices, an example of which is a smart phone 1200 illustrated in FIG. 12. A mobile computing device, such as a smart phone 1200, may include a processor 1201 coupled to memory 1202 and to a radio frequency data modem 1205. The modem 1205 may be coupled to an antenna 1204 for receiving and transmitting radio frequency signals. The smart phone 1200 may also include a display 1203, such as a touchscreen display. The mobile computing device may also include user input devices, such as buttons 1206 and/or a touchscreen display 1203, to receive user inputs. The smart phone 1200 may also include a camera 1213, preferably a digital camera, for taking and storing picture and video images.

The mobile computing device processor 1201 may be any programmable microprocessor, microcomputer or multiple processor chip or chips that may be configured by software instructions (applications) to perform a variety of functions, including the functions of the various embodiments described herein.

Typically, software applications may be stored in the internal memory 1202 before they are accessed and loaded into the processor 1201. In some mobile computing devices, additional memory chips (e.g., a Secure Data (SD) card) may be plugged into the mobile computing device and coupled to the processor 1201. The internal memory 1202 may be a volatile or nonvolatile memory, such as flash memory, or a mixture of both. For the purposes of this description, a general reference to memory refers to all memory accessible by the processor 1201, including internal memory 1202, removable memory plugged into the mobile computing device, and memory within the processor 1201.

Various embodiments may also be implemented on any of a variety of commercially available server devices, such as the server 1300 illustrated in FIG. 13. Such a server 1300 typically includes a processor 1301 coupled to volatile memory 1302 and a large capacity nonvolatile memory, such as a disk drive 1303. The server 1300 may also include a floppy disc drive, compact disc (CD) or DVD disc drive 1306 coupled to the processor 1301. The server 1300 may also include network access ports 1304 coupled to the processor 1301 for establishing data connections with a network 1305, such as a local area network coupled to other broadcast system computers and servers. The server processor 1301 may be any programmable microprocessor, microcomputer or multiple processor chip or chips that can be configured by software instructions (applications) to perform a variety of functions, including the functions of the various embodiments described above. Typically, software applications may be stored in the internal memory 1302, and 1303 before they are accessed and loaded into the processor 1301. The processor 1301 may include internal memory sufficient to store software instructions. For the purposes of this description, a general reference to memory refers to memory accessible by the processor 1301 including volatile memory 1302, disk drives 1303, floppy disc drives, CD/DVD disc drives 1306 and memory within the processor 1301 itself.

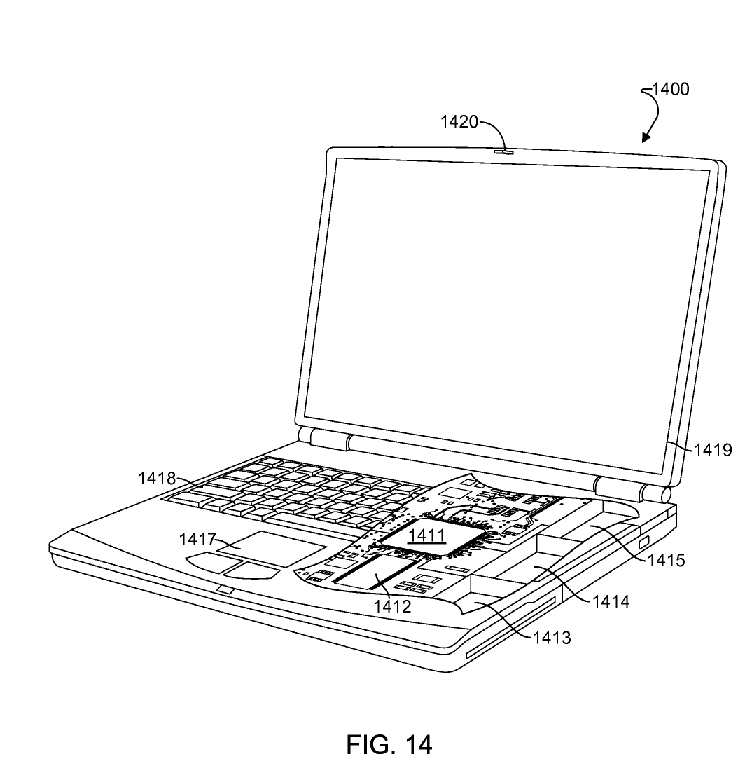

The embodiments described above may also be implemented within a variety of personal computing devices, such as a laptop computer 1410 as illustrated in FIG. 14. A laptop computer 1410 will typically include a processor 1411 coupled to volatile memory 1412 and a large capacity nonvolatile memory, such as a disk drive 1413 or Flash memory. The computer 1410 may also include a compact disc (CD) drive 1414 coupled to the processor 1411. In order to send or receive wireless data, the computer 1410 may further include a wireless modem 1415 coupled to an antenna (embedded in the display portion 1419), with the wireless modem 1415 configured to enable the processor to receive and transmit data via a wireless network, such as cellular data network. Some computing devices may also include a WiFi transceiver, which in some embodiments may be included as part of the wireless modem 1415. The computer device 1410 may also include a number of connector ports coupled to the processor 1411 for establishing data connections or receiving external memory devices, such as a USB or FireWire® connector sockets, or other network connection circuits for coupling the processor 1411 to a network, such as the Internet. In a notebook configuration, the computer housing includes the touchpad 1417, the keyboard 1418, and the display 1419 all coupled to the processor 1411. The computer 1410 may also include a camera 1420, preferably a digital camera, for taking and storing picture and video images.

The foregoing method descriptions and the process flow diagrams are provided merely as illustrative examples and are not intended to require or imply that the operations or steps of the various embodiments must be performed in the order presented. As will be appreciated by one of skill in the art the order of blocks in the foregoing embodiments may be performed in any order. Words such as “thereafter,” “then,” “next,” etc. are not intended to limit the order of the operations or steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The embodiment methods described herein may be implemented in a computing device by configuring a processor of the computing device with processor-executable instructions to perform the operations of the method. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the operations and functions described may be implemented in hardware, software, firmware, or any combination thereof. If implemented in software, the functions may be stored on or transmitted over as one or more instructions or code on a computer-readable medium. The operations of a method or algorithm disclosed herein may be embodied in a processor-executable software module which may be stored on a non-transitory computer-readable medium or processor-readable medium. Non-transitory computer-readable and processor-readable media may be any available storage media that may be accessed by a computer or processor. By way of example, and not limitation, such non-transitory computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein.

What is claimed is:

1. A method of uploading files to a social media website, comprising:
receiving in a first computing device a user input identifying files for upload to a social media website;
selecting one or more files representative of the selected files;
uploading the selected one or more representative files to a social media website server;
receiving in the first computing device from the social media website server a request for upload of files similar to identified particular representative files; and
uploading to the social media server additional files that are similar to the identified particular representative files.

2. The method of claim 1, wherein the files comprise media files comprising at least one of photograph files, video files, audio files and text files.

3. The method of claim 1, wherein the selected representative files are selected based on one or more of subject matter, timestamp data or location data.

4. The method of claim 1, wherein a number of the representative files selected for upload is based in part on file sizes.

5. The method of claim 1, further comprising:
selecting in the first computing device the additional files to upload similar to the certain identified particular representative files based on one or more of subject matter, timestamp data, location data and metadata.

6. The method of claim 5, further comprising using facial recognition software to select additional files to upload.

7. The method of claim 1, further comprising:
posting in a server of the social media website the received selected one or more representative files to the social media website;
tracking in the server interactions of users of the social media website with the posted one or more representative files;
determining in the server when interactions with a particular uploaded file exceeds a popularity threshold value;
transmitting a request from the server to the first computing device for upload of additional files that are similar to the particular uploaded file having interactions exceeding the popularity threshold value;
receiving in the server an upload of the additional files from the first computing device, and
posting in the server the additional files on the social media website.

8. The method of claim 7, wherein the interactions of users with a particular uploaded file comprise one or more of access requests for the file; posted comments, posted tags, posted reviews, requested links, and requests to forward the file.

9. The method of claim 7, wherein the popularity threshold is set by the social media website server.

10. The method of claim 7, wherein the popularity threshold is set by a user of the computing device.

11. The method of claim 7, further comprising:
receiving in the server an authorization from the first computing device to display advertising on the user's social media website;
displaying advertising content on the user's social media website; and
compensating a user of the computing device for the display of advertising content.

12. The method of claim 11, wherein the compensation comprises at least part of a cost associated with uploading additional files that are similar to the identified particular representative files.

13. The method of claim 7, further comprising:
displaying a file request option in a user interface on a second computing device in response to an interaction with a media file;
receiving in the second computing device a user input in response to the displayed file request option;
transmitting a request to the first computing device for uploading of additional files that are similar to a particular file; and
selecting in the first computing device additional files for upload based on the user input data.

14. The method of claim 7, further comprising:
tracking in the server interactions with portions of the one or more representative files; and
transmitting a request from the server to the first computing device for upload of files having similar subject matter as portions of the one or more representative files.

15. The method of claim 14, wherein portions of the one or more representative files comprise a person's face, and the requested files comprise other photographs of the person.

16. The method of claim 15, further comprising:
identifying in the first computing device files having similar subject matter using one or more of facial recognition software and metadata in the files.

17. The method of claim 14, further comprising:
transmitting the request for uploading of files having similar subject matter to a plurality of second computing devices of users of the social media site.

18. The method of claim 1, further comprising:
receiving in the server from the first computing device authorization for a second computing device of a content editor to access media files on the computing device,
wherein selecting one or more files representative of the selected files comprises receiving in the first computing device a selection of files submitted by the content editor.

19. The method of claim 18, further comprising:
tracking interactions of users of the social media website with the posted one or more representative files; and
providing a reward to the second computing device of the content editor based on user interactions with the posted one or more representative files.

20. A computing device, comprising:
a display;
a memory; and
a processor coupled to the display and to the memory and configured with processor-executable instructions to perform operations comprising:
receiving a user input identifying files for upload to a social media website;
selecting one or more files representative of the selected files;
uploading the selected one or more representative files to a social media website server;
receiving from the social media website server a request for upload of files similar to identified particular representative files; and
uploading to the social media server additional files that are similar to the identified particular representative files.

21. The computing device of claim 20, wherein the files comprise media files comprising at least one of photograph files, video files, audio files and text files.

22. The computing device of claim 20, wherein the processor is configured with processor-executable instructions to perform operations such that the selected representative files are selected based on one or more of subject matter, timestamp data or location data.

23. The computing device of claim 20, wherein the processor is configured with processor-executable instructions to perform operations such that a number of the representative files selected for upload is based in part on file sizes.

24. The computing device of claim 20, wherein the processor is configured with processor-executable instructions to perform operations further comprising:
selecting the additional files to upload similar to the certain identified particular representative files based on one or more of subject matter, timestamp data, location data and metadata.

25. The computing device of claim 20, wherein the processor is configured with processor-executable instructions to perform operations further comprising:
using facial recognition software to select additional files to upload.

26. A system, comprising:
a server coupled to a communications network; and
a first computing device connected to the server over the communications network,
wherein the server comprises a memory and a processor coupled to the memory, and wherein the processor is configured with processor-executable instructions to perform operations comprising:
posting selected one or more representative files, uploaded from the first computing device, to a social media website;
tracking interactions of users of the social media website with the posted one or more representative files;
determining when interactions with a particular uploaded file exceeds a popularity threshold value;
transmitting a request to the first computing device for upload of additional files that are similar to the particular uploaded file having interactions exceeding the popularity threshold value;
receiving an upload of the additional files from the first computing device, and
posting the additional files on the social media website.

27. The system of claim 26, wherein the interactions of users with a particular uploaded file comprise one or more of access requests for the file, posted comments, posted tags, posted reviews, requested links, and requests to forward the file.

28. The system of claim 26, wherein the processor of the server is configured with processor-executable instructions to perform operations further comprising:
setting the popularity threshold value.

29. The system of claim 26, wherein the first computing device comprises a memory and a processor coupled to the memory, and wherein the processor of the first computing device is configured with processor-executable instructions to perform operations comprising:
setting of the popularity threshold value.

30. The system of claim 26, wherein the processor of the server is configured with processor-executable instructions to perform operations further comprising:
receiving an authorization from the first computing device to display advertising on the user's social media website;
displaying advertising content on the user's social media website; and
compensating a user of the computing device for the display of advertising content.

31. The system of claim 30, wherein the compensation comprises at least part of a cost associated with uploading additional files that are similar to the identified particular representative files.

32. The system of claim 26, further comprising:
a second computing device connected to the server over the communications network,
wherein the second computing device comprises a display, a memory and a processor coupled to the display and to the memory and configured with processor-executable instructions to perform operations comprising:
displaying a file request option in a user interface in response to an interaction with a media file on a social media website;
receiving a user input in response to the displayed file request option; and
transmitting a request to the first computing device for uploading of additional files that are similar to a particular file,
wherein the first computing device comprises a display, a memory and a processor coupled to the display and to the memory and configured with processor-executable instructions to perform operations comprising:
selecting additional files for upload based on the user input data.

33. The system of claim 26, wherein the processor of the server is configured with processor-executable instructions to perform operations further comprising:
tracking interactions with portions of the one or more representative files; and
transmitting a request to the first computing device for upload of files having similar subject matter as portions of the one or more representative files.

34. The system of claim 33, wherein the portions of the one or more representative files comprise a person's face, and the requested files comprise other photographs of the person.

35. The system of claim 33, wherein the processor of the first computing device is configured with processor-executable instructions to perform operations further comprising:
identifying files having similar subject matter using one or more of facial recognition software and metadata in the files.

36. The system of claim 33, wherein the processor of the server is configured with processor-executable instructions to perform operations further comprising:
transmitting the request for uploading of files having similar subject matter to a plurality of computing devices of users of the social media site.

37. The system of claim 26, wherein the processor of the server is configured with processor-executable instructions to perform operations further comprising:
receiving from the first computing device authorization for a second computing device of a content editor to access media files on the computing device; and
receiving a selection of one or more representative files selected by the content editor.

38. The system of claim 37, wherein the processor of the server is configured with processor-executable instructions to perform operations further comprising:
tracking interactions of users of the social media website with the posted one or more representative files; and
providing a reward to the second computing device of the content editor based on user interactions with the posted one or more representative files.

39. A computing device, comprising:
means for receiving a user input identifying files for upload to a social media website;
means for selecting one or more files representative of the selected files;
means for uploading the selected one or more representative files to a social media website server;
means for receiving from the social media website server a request for upload of files similar to identified particular representative files; and
means for uploading to the social media server additional files that are similar to the identified particular representative files.

40. The computing device of claim 39, wherein the files comprise media files comprising at least one of photograph files, video files, audio files and text files.

41. The computing device of claim 39, further comprising:
means for selecting the representative files based on one or more of subject matter, timestamp data and location data.

42. The computing device of claim 39, further comprising:
means for selecting a number of representative files for upload based in part on file sizes.

43. The computing device of claim 39, further comprising:
means for selecting the additional files to upload similar to the certain identified particular representative files based on one or more of subject matter, timestamp data, location data and metadata.

44. The computing device of claim 43, further comprising facial recognition software means for selecting additional files to upload.

45. A system for uploading files to a social media website, comprising:
means for posting in a server selected one or more representative files, uploaded from a first computing device, to a social media website;
means for tracking in the server interactions of users of the social media website with the posted one or more representative files;
means for determining in the server when interactions with a particular uploaded file exceeds a popularity threshold value;
means for transmitting a request from the server to the first computing device for upload of additional files that are similar to the particular uploaded file having interactions exceeding the popularity threshold value;
means for receiving in the server an upload of the additional files from the first computing device, and
means for posting in the server the additional files on the social media website.

46. The system of claim 45, wherein the interactions of users with a particular uploaded file comprise one or more of access requests for the file, posted comments, posted tags, posted reviews, requested links, and requests to forward the file.

47. The system of claim 45, further comprising:
means for setting the popularity threshold value in the social media website server.

48. The system of claim 45, further comprising:
means for setting the popularity threshold value in the computing device of a user of the social media website.

49. The system of claim 45, further comprising:
means for receiving in the server an authorization from the first computing device to display advertising on the user's social media website;
means for displaying advertising content on the user's social media website; and
means for compensating a user of the first computing device for the display of advertising content.

50. The system of claim 49, wherein the compensation comprises at least part of a cost associated with uploading additional files that are similar to the identified particular representative files.

51. The system of claim 45, further comprising:
means for displaying a file request option in a user interface on a second computing device in response to an interaction with a media file;
means for receiving in the second computing device a user input in response to the displayed file request option;
means for transmitting a request to the first computing device for uploading of additional files that are similar to a particular file; and
means for selecting in the first computing device additional files for upload based on the user input data.

52. The system of claim 45, further comprising:
means for tracking in the server interactions with portions of the one or more representative files; and
means for transmitting a request from the server to the first computing device for upload of files having similar subject matter as portions of the one or more representative files.

53. The system of claim 52, wherein portions of the one or more representative files comprise a person's face, and the requested files comprise other photographs of the person.

54. The system of claim 52, further comprising:
identifying in the first computing device files having similar subject matter using one or more of facial recognition software and metadata in the files.

55. The system of claim 52, further comprising:
means for transmitting the request for uploading of files having similar subject matter to a plurality of second computing devices of users of the social media site.

56. The system of claim 45, further comprising:
means for receiving in the server from the first computing device authorization for a second computing device of a content editor to access media files on the computing device; and
means for receiving in the first computing device the selection of one or more representative files submitted by the content editor.

57. The system of claim 56, further comprising:
means for tracking interactions of users of the social media website with the posted one or more representative files; and
means for providing a reward to the second computing device of the content editor based on user interactions with the posted one or more representative files.

58. A non-transitory computer-readable storage medium having stored thereon processor executable instructions configured to cause a computing device processor to perform operations comprising:
receiving a user input identifying files for upload to a social media website;
selecting one or more files representative of the selected files;
uploading the selected one or more representative files to a social media website server;
receiving from the social media website server a request for upload of files similar to identified particular representative files; and
uploading to the social media server additional files that are similar to the identified particular representative files.

59. The non-transitory computer-readable storage medium of claim 58, wherein the stored processor executable instructions are configured to cause the computing device processor to perform operations and wherein the files comprise media files comprising at least one of photograph files, video files, audio files and text files.

60. The non-transitory computer-readable storage medium of claim 58, wherein the stored processor executable instructions are configured to cause the computing device processor to perform operations further comprising selecting representative files based on one or more of subject matter, timestamp data or location data.

61. The non-transitory computer-readable storage medium of claim 58, wherein the stored processor executable instructions are configured to cause the computing device processor to perform operations further comprising selecting a number of the representative files for upload based in part on file sizes.

62. The non-transitory computer-readable storage medium of claim 58, wherein the stored processor executable instructions are configured to cause the computing device processor to perform operations further comprising:
selecting the additional files to upload similar to the certain identified particular representative files based on one or more of subject matter, timestamp data, location data and metadata.

63. The non-transitory computer-readable storage medium of claim 58, wherein the stored processor executable instructions are configured to cause the computing device processor to perform operations further comprising:
using facial recognition software to select additional files to upload.

64. A non-transitory computer-readable storage medium having stored thereon processor executable instructions configured to cause a server processor to perform operations comprising:
posting selected one or more representative files, uploaded from a first computing device, to a social media website;
tracking interactions of users of the social media website with the posted one or more representative files;
determining when interactions with a particular uploaded file exceeds a popularity threshold value;
transmitting a request to the first computing device for upload of additional files that are similar to the particular uploaded file having interactions exceeding the popularity threshold value;
receiving an upload of the additional files from the first computing device, and
posting the additional files on the social media website.

65. The non-transitory computer-readable storage medium of claim 64, wherein the stored processor executable instructions are configured to cause the server processor to perform operations and wherein the interactions of users with a particular uploaded file comprise one or more of access requests for the file, posted comments, posted tags, posted reviews, requested links, and requests to forward the file.

66. The non-transitory computer-readable storage medium of claim 64, wherein the stored processor executable instructions are configured to cause the server processor to perform operations further comprising:
setting the popularity threshold value.

67. The non-transitory computer-readable storage medium of claim 64, wherein the stored processor executable instructions are configured to cause the server processor to perform operations further comprising:
receiving a setting of the popularity threshold value from the first computing device.

68. The non-transitory computer-readable storage medium of claim 64, wherein the stored processor executable instructions are configured to cause the server processor to perform operations further comprising:
receiving an authorization from the first computing device to display advertising on the user's social media website;
displaying advertising content on the user's social media website; and
compensating a user of the computing device for the display of advertising content.

69. The non-transitory computer-readable storage medium of claim 68, wherein the stored processor executable instructions are configured to cause the server processor to perform operations and wherein the compensation comprises at least part of a cost associated with uploading additional files that are similar to the identified particular representative files.

70. The non-transitory computer-readable storage medium of claim 64, wherein the stored processor executable instructions are configured to cause the server processor to perform operations further comprising:
tracking interactions with portions of the one or more representative files; and
transmitting a request to the first computing device for upload of files having similar subject matter as portions of the one or more representative files.

71. The non-transitory computer-readable storage medium of claim 70, wherein the stored processor executable instructions are configured to cause the server processor to perform operations and wherein the portions of the one or more representative files comprise a person's face, and the requested files comprise other photographs of the person.

72. The non-transitory computer-readable storage medium of claim 70, wherein the stored processor executable instructions are configured to cause the server processor to perform operations further comprising:
transmitting the request for uploading of files having similar subject matter to a plurality of computing devices of users of the social media site.

73. The non-transitory computer-readable storage medium of claim 64, wherein the stored processor executable instructions are configured to cause the server processor to perform operations further comprising:
receiving from the first computing device authorization for a second computing device of a content editor to access media files on the computing device; and
receiving a selection of one or more representative files selected by the content editor.

74. The non-transitory computer-readable storage medium of claim 73, wherein the stored processor executable instructions are configured to cause the server processor to perform operations further comprising:
tracking interactions of users of the social media website with the posted one or more representative files; and
providing a reward to the second computing device of the content editor based on user interactions with the posted one or more representative files.
